(19) United States
(12) Patent Application Publication
(10) Pub. No.: US 2025/0240733 A1
(43) Pub. Date: Jul. 24, 2025

(54) FULL DUPLEX CLOSED LOOP UPLINK POWER CONTROL COMMANDS

(71) Applicant: QUALCOMM Incorporated, San Diego, CA (US)

(72) Inventors: Ahmed Attia ABOTABL, San Diego, CA (US); Abdelrahman Mohamed Ahmed Mohamed IBRAHIM, San Diego, CA (US); Muhammad Sayed Khairy ABDELGHAFFAR, San Jose, CA (US)

(21) Appl. No.: 18/416,583

(22) Filed: Jan. 18, 2024

(51) Int. Cl. H04W 52/14; H04L 5/14; H04W 52/08; H04W 72/232

(52) U.S. Cl. CPC H04W 52/146; H04L 5/14; H04W 52/08; H04W 72/232

(57) ABSTRACT

Methods, systems, and devices for wireless communications are described. A user equipment (UE) may transmit uplink communications to a network entity using a set of open loop and closed loop power control parameters. Open loop parameters may be configured in radio resource control. Closed loop parameters may be indicated in uplink scheduling information (e.g., a transmit power control (TPC) field in scheduling downlink control information (DCI)) or in a DCI format dedicated for providing TPC commands. The network may configure different closed loop power control states for half duplex (HD) and full duplex (FD), and the UE may apply a TPC command to an HD or FD closed loop power control state based on whether the TPC command is an HD type TPC command or an FD type TPC command. DCI may indicate whether an included TPC command is an HD type TPC command or an FD type TPC command.

### FIELD OF TECHNOLOGY

The following relates to wireless communications, including full duplex closed loop uplink power control commands.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support full duplex (FD) closed loop uplink power control commands. For example, the described techniques provide for separate uplink FD transmit power control (TPC) commands and half duplex (HD) TPC commands. A user equipment (UE) may transmit uplink communications to a network entity using a set of open loop and closed loop power control parameters. Open loop parameters may be configured in radio resource control (RRC). Closed loop parameters may be indicated by the network entity in scheduling information for an uplink transmission (e.g., TPC field in a scheduling downlink control information (DCI)) or in a DCI format dedicated for providing TPC commands. To account for differences in cross-link interference (CLI) or self-interference in HD and FD resources the network may configure different closed loop power control states for HD and FD, and the UE may apply a TPC command to an HD or FD closed loop power control state based on whether the TPC command is an HD type TPC command or an FD type TPC command. A DCI may indicate whether an included TPC command is an HD type TPC command or an FD type TPC command.

A method for wireless communications by a UE is described. The method may include receiving control signaling that indicates a set of HD time resources and a set of FD time resources, receiving DCI that includes an uplink TPC command, where the DCI or receipt of the DCI is indicative of the uplink TPC command being a FD type uplink TPC command, and transmitting an uplink communication in a time resource of the set of FD time resources in accordance with the uplink TPC command.

A UE for wireless communications is described. The UE may include one or more memories storing processor executable code, and one or more processors coupled with the one or more memories. The one or more processors may individually or collectively be operable to execute the code to cause the UE to receive control signaling that indicates a set of HD time resources and a set of FD time resources, receive DCI that includes an uplink TPC command, where the DCI or receipt of the DCI is indicative of the uplink TPC command being a FD type uplink TPC command, and transmit an uplink communication in a time resource of the set of FD time resources in accordance with the uplink TPC command.

Another UE for wireless communications is described. The UE may include means for receiving control signaling that indicates a set of HD time resources and a set of FD time resources, means for receiving DCI that includes an uplink TPC command, where the DCI or receipt of the DCI is indicative of the uplink TPC command being a FD type uplink TPC command, and means for transmitting an uplink communication in a time resource of the set of FD time resources in accordance with the uplink TPC command.

A non-transitory computer-readable medium storing code for wireless communications is described. The code may include instructions executable by one or more processors to receive control signaling that indicates a set of HD time resources and a set of FD time resources, receive DCI that includes an uplink TPC command, where the DCI or receipt of the DCI is indicative of the uplink TPC command being a FD type uplink TPC command, and transmit an uplink communication in a time resource of the set of FD time resources in accordance with the uplink TPC command.

In some examples of the method, UEs, and non-transitory computer-readable medium described herein, receiving the DCI may include operations, features, means, or instructions for receiving the DCI scrambled by a radio network temporary identifier (RNTI) for the UE associated with the set of FD time resources; where the DCI may be indicative of the uplink TPC command being the FD type uplink TPC command based on the DCI being scrambled by the RNTI associated with the set of FD time resources.

Some examples of the method, UEs, and non-transitory computer-readable medium described herein may further include operations, features, means, or instructions for receiving, via the control signaling or via second control signaling, an indication of the RNTI for the UE.

Some examples of the method, UEs, and non-transitory computer-readable medium described herein may further include operations, features, means, or instructions for receiving, via the control signaling or via second control signaling, an indication of a second RNTI for the UE associated with the set of HD time resources and determining the RNTI for the UE based on the second RNTI.

In some examples of the method, UEs, and non-transitory computer-readable medium described herein, the DCI may have a format associated with the set of FD time resources and the DCI may be indicative of the uplink TPC command being the FD type uplink TPC command based on the format.

In some examples of the method, UEs, and non-transitory computer-readable medium described herein, receiving the DCI may include operations, features, means, or instructions for receiving the DCI that includes a second uplink TPC command of a HD type uplink TPC command, where the DCI may be indicative of the uplink TPC command being the FD type uplink TPC command based on a location of the uplink TPC command within the DCI.

Some examples of the method, UEs, and non-transitory computer-readable medium described herein may further include operations, features, means, or instructions for receiving, via the control signaling or via second control signaling, an indication of a first location within a DCI format associated with FD type uplink TPC commands and a second location within the DCI format associated with HD type uplink TPC commands, where the DCI may have the DCI format, where the location may be the first location, and where the second uplink TPC command may be within the second location.

In some examples of the method, UEs, and non-transitory computer-readable medium described herein, the location may be adjacent to a second location of the second uplink TPC command.

In some examples of the method, UEs, and non-transitory computer-readable medium described herein, the location may be a configured offset from a second location of the second uplink TPC command.

In some examples of the method, UEs, and non-transitory computer-readable medium described herein, receiving the DCI may include operations, features, means, or instructions for receiving the DCI scheduling the uplink communication in the time resource, where the receipt of the DCI may be indicative of the uplink TPC command being the FD type uplink TPC command based on the time resource being a FD time resource.

In some examples of the method, UEs, and non-transitory computer-readable medium described herein, receiving the DCI may include operations, features, means, or instructions for receiving the DCI that includes a field indicating that the uplink TPC command may be the FD type uplink TPC command.

Some examples of the method, UEs, and non-transitory computer-readable medium described herein may further include operations, features, means, or instructions for receiving, via the control signaling or via second control signaling, an indication that a first uplink TPC command accumulator may be associated with FD type uplink TPC commands and a second uplink TPC command accumulator may be associated with HD type uplink TPC commands, where the uplink TPC command may be applied to the first uplink TPC command accumulator based on the uplink TPC command being the FD type uplink TPC command, and where the uplink communication may be transmitted in accordance with the first uplink TPC command accumulator.

Some examples of the method, UEs, and non-transitory computer-readable medium described herein may further include operations, features, means, or instructions for receiving second DCI that includes a second uplink TPC command, where the second DCI or receipt of the second DCI may be indicative of the second uplink TPC command being a HD type uplink TPC command, and where the second uplink TPC command may be applied to the second uplink TPC command accumulator based on the second uplink TPC command being the HD type uplink TPC command and transmitting a second uplink communication in a second time resource of the set of HD time resources in accordance with the second uplink TPC command accumulator.

Some examples of the method, UEs, and non-transitory computer-readable medium described herein may further include operations, features, means, or instructions for receiving, via the control signaling or via the second control signaling, an indication that a third uplink TPC command accumulator may be associated with the FD type uplink TPC commands and that a fourth uplink TPC command accumulator may be associated with the HD type uplink TPC commands.

A method for wireless communications by a network entity is described. The method may include outputting, to a UE, control signaling that indicates a set of HD time resources and a set of FD time resources, outputting, to the UE, DCI that includes an uplink TPC command, where the DCI or transmission of the DCI is indicative of the uplink TPC command being a FD type uplink TPC command, and obtaining, from the UE, an uplink communication in a time resource of the set of FD time resources in accordance with the uplink TPC command.

A network entity for wireless communications is described. The network entity may include one or more memories storing processor executable code, and one or more processors coupled with the one or more memories. The one or more processors may individually or collectively be operable to execute the code to cause the network entity to output, to a UE, control signaling that indicates a set of HD time resources and a set of FD time resources, output, to the UE, DCI that includes an uplink TPC command, where the DCI or transmission of the DCI is indicative of the uplink TPC command being a FD type uplink TPC command, and obtain, from the UE, an uplink communication in a time resource of the set of FD time resources in accordance with the uplink TPC command.

Another network entity for wireless communications is described. The network entity may include means for outputting, to a UE, control signaling that indicates a set of HD time resources and a set of FD time resources, means for outputting, to the UE, DCI that includes an uplink TPC command, where the DCI or transmission of the DCI is indicative of the uplink TPC command being a FD type uplink TPC command, and means for obtaining, from the UE, an uplink communication in a time resource of the set of FD time resources in accordance with the uplink TPC command.

A non-transitory computer-readable medium storing code for wireless communications is described. The code may include instructions executable by one or more processors to output, to a UE, control signaling that indicates a set of HD time resources and a set of FD time resources, output, to the UE, DCI that includes an uplink TPC command, where the DCI or transmission of the DCI is indicative of the uplink TPC command being a FD type uplink TPC command, and obtain, from the UE, an uplink communication in a time resource of the set of FD time resources in accordance with the uplink TPC command.

In some examples of the method, network entities, and non-transitory computer-readable medium described herein, outputting the DCI may include operations, features, means, or instructions for outputting the DCI scrambled by a RNTI for the UE associated with the set of FD time resources; where the DCI may be indicative of the uplink TPC command being the FD type uplink TPC command based on the DCI being scrambled by the RNTI associated with the set of FD time resources.

Some examples of the method, network entities, and non-transitory computer-readable medium described herein may further include operations, features, means, or instructions for outputting, to the UE via the control signaling or via second control signaling, an indication of the RNTI for the UE.

Some examples of the method, network entities, and non-transitory computer-readable medium described herein may further include operations, features, means, or instructions for outputting, to the UE via the control signaling or via second control signaling, an indication of a second RNTI for the UE associated with the set of HD time resources, where the RNTI may be derivative of the second RNTI.

In some examples of the method, network entities, and non-transitory computer-readable medium described herein, the DCI may have a format associated with the set of FD time resources and the DCI may be indicative of the uplink TPC command being the FD type uplink TPC command based on the format.

In some examples of the method, network entities, and non-transitory computer-readable medium described herein, outputting the DCI may include operations, features, means, or instructions for outputting the DCI that includes a second uplink TPC command of a HD type uplink TPC command, where the DCI may be indicative of the uplink TPC command being the FD type uplink TPC command based on a location of the uplink TPC command within the DCI.

Some examples of the method, network entities, and non-transitory computer-readable medium described herein may further include operations, features, means, or instructions for outputting, to the UE via the control signaling or via second control signaling, an indication of a first location within a DCI format associated with FD type uplink TPC commands and a second location within the DCI format associated with HD type uplink TPC commands, where the DCI may have the DCI format, where the location may be the first location, and where the second uplink TPC command may be within the second location.

In some examples of the method, network entities, and non-transitory computer-readable medium described herein, the location may be adjacent to a second location of the second uplink TPC command.

In some examples of the method, network entities, and non-transitory computer-readable medium described herein, the location may be a configured offset from a second location of the second uplink TPC command.

In some examples of the method, network entities, and non-transitory computer-readable medium described herein, outputting the DCI may include operations, features, means, or instructions for outputting the DCI scheduling the uplink communication in the time resource, where the transmission of the DCI may be indicative of the uplink TPC command being the FD type uplink TPC command based on the time resource being a FD time resource.

In some examples of the method, network entities, and non-transitory computer-readable medium described herein, outputting the DCI may include operations, features, means, or instructions for outputting the DCI that includes a field indicating that the uplink TPC command may be the FD type uplink TPC command.

Some examples of the method, network entities, and non-transitory computer-readable medium described herein may further include operations, features, means, or instructions for outputting, to the UE via the control signaling or via second control signaling, an indication that a first uplink TPC command accumulator may be associated with FD type uplink TPC commands and a second uplink TPC command accumulator may be associated with HD type uplink TPC commands, where the uplink TPC command may be applied to the first uplink TPC command accumulator based on the uplink TPC command being the FD type uplink TPC command, and where the uplink communication may be obtained in accordance with the first uplink TPC command accumulator.

Some examples of the method, network entities, and non-transitory computer-readable medium described herein may further include operations, features, means, or instructions for outputting, to the UE, second DCI that includes a second uplink TPC command, where the second DCI or transmission of the second DCI may be indicative of the second uplink TPC command being a HD type uplink TPC command, and where the second uplink TPC command may be applied to the second uplink TPC command accumulator based on the second uplink TPC command being the HD type uplink TPC command and obtaining, from the UE, a second uplink communication in a second time resource of the set of HD time resources in accordance with the second uplink TPC command accumulator.

Some examples of the method, network entities, and non-transitory computer-readable medium described herein may further include operations, features, means, or instructions for outputting, to the UE via the control signaling or via the second control signaling, an indication that a third uplink TPC command accumulator may be associated with the FD type uplink TPC commands and that a fourth uplink TPC command accumulator may be associated with the HD type uplink TPC commands.

### BRIEF DESCRIPTION OF THE DRAWINGS

FIG. 1 shows an example of a wireless communications system that supports full duplex (FD) closed loop uplink power control commands in accordance with one or more aspects of the present disclosure.

FIG. 2 shows an example of a resource diagram that supports FD closed loop uplink power control commands in accordance with one or more aspects of the present disclosure.

FIG. 3 shows an example of a wireless communications system that supports FD closed loop uplink power control commands in accordance with one or more aspects of the present disclosure.

FIG. 4 shows example diagrams of downlink control information that supports FD closed loop uplink power control commands in accordance with one or more aspects of the present disclosure.

FIG. 5 shows an example of a process flow that supports FD closed loop uplink power control commands in accordance with one or more aspects of the present disclosure.

FIGS. 6 and 7 show block diagrams of devices that support FD closed loop uplink power control commands in accordance with one or more aspects of the present disclosure.

FIG. 8 shows a block diagram of a communications manager that supports FD closed loop uplink power control commands in accordance with one or more aspects of the present disclosure.

FIG. 9 shows a diagram of a system including a device that supports FD closed loop uplink power control commands in accordance with one or more aspects of the present disclosure.

FIGS. 10 and 11 show block diagrams of devices that support FD closed loop uplink power control commands in accordance with one or more aspects of the present disclosure.

FIG. 12 shows a block diagram of a communications manager that supports FD closed loop uplink power control commands in accordance with one or more aspects of the present disclosure.

FIG. 13 shows a diagram of a system including a device that supports FD closed loop uplink power control commands in accordance with one or more aspects of the present disclosure.

FIGS. 14 and 15 show flowcharts illustrating methods that support FD closed loop uplink power control commands in accordance with one or more aspects of the present disclosure.

### DETAILED DESCRIPTION

A wireless communications system may implement full duplex (FD) communication according to which network devices may simultaneously transmit and receive. For example, a network entity may employ subband full duplex (SBFD) according to which the network entity may receive via a first set of one or more subbands (which may be referred to as uplink subbands) and transmit via a second set of one or more subbands (which may be referred to as downlink subbands), where the first and second sets of subbands may be non-overlapping in the frequency domain. Within a carrier, FD time resources (e.g., slots or symbols) may be interspersed with half duplex (HD) time resources. For example, an HD time resource may refer to a time resource where the entire carrier bandwidth is configured or used for uplink or downlink.

A user equipment (UE) may transmit uplink communications to a network entity using a set of open loop and closed loop power control parameters. Open loop parameters may be configured in radio resource control (RRC). Closed loop parameters may be indicated by the network entity in scheduling information for an uplink transmission (e.g., a transmit power control (TPC) field in a scheduling downlink control information (DCI)) or in a DCI format dedicated for providing TPC commands (e.g., DCI format 2_2). For example, in a DCI format 2_2, a particular UE may identify an included TPC command as being for the particular UE based on a radio network temporary identifier (RNTI) used to scramble the cyclic redundancy check (CRC) of the DCI. For closed loop power control, the UE may maintain power states (e.g., an accumulator of TPC commands) and may determine the total adjustment based on the applicable power state. The uplink transmit power with which a UE transmits an uplink communication may affect the level of cross-link interference (CLI) experienced by the network entity and other UEs caused by the uplink communication. SBFD time resources may be more susceptible to causing CLI than uplink time resources (e.g., HD time resources dedicated for uplink), as some UEs may be scheduled to receive downlink communications in a same time resource that another UE is scheduled to transmit. Additionally, different network entities may operate in different time division duplexing (TDD) patterns, meaning that some HD uplink time resources may cause CLI between UEs served by different network entities while other uplink time resources may not cause CLI between UEs. If only one set of uplink power control parameters is configured for a UE, the UE may not be able to adjust uplink power for different interference conditions caused by FD versus HD time resources.

The network may transmit separate closed loop FD TPC commands and HD TPC commands via DCI (e.g., either via scheduling DCI or a dedicated DCI such as a DCI format 2_2). The DCI or reception of the DCI may indicate whether the TPC command is an HD type TPC command or an FD type TPC command. For example, the UE may identify whether a DCI format 2_2 includes an HD type TPC command or an FD type TPC command based on whether the CRC of the DCI format 2_2 is scrambled with an RNTI associated with HD type TPC commands or FD type TPC commands. As another example, each DCI format 2_2 may include an HD type TPC command and an FD type TPC command, and the UE may identify the HD and FD type TPC commands based on the relative locations within the DCI. As another example, a new DCI format may be defined for providing FD TPC commands. As another example, for a scheduling DCI, the UE may identify whether the TPC command is an HD type TPC command or an FD type TPC command based on whether the DCI schedules an uplink communication in an FD or HD type slot. The network may configure different closed loop power control states (e.g., accumulators) for HD and FD for the UE, and the UE may apply a TPC command to an HD or FD closed loop power control state based on whether the TPC command is an HD type TPC command or an FD type TPC command.

Aspects of the disclosure are initially described in the context of wireless communications systems. Aspects of the disclosure are further illustrated by and described with reference to resource diagrams, diagrams of DCI, process flows, apparatus diagrams, system diagrams, and flowcharts that relate to FD closed loop uplink power control commands.

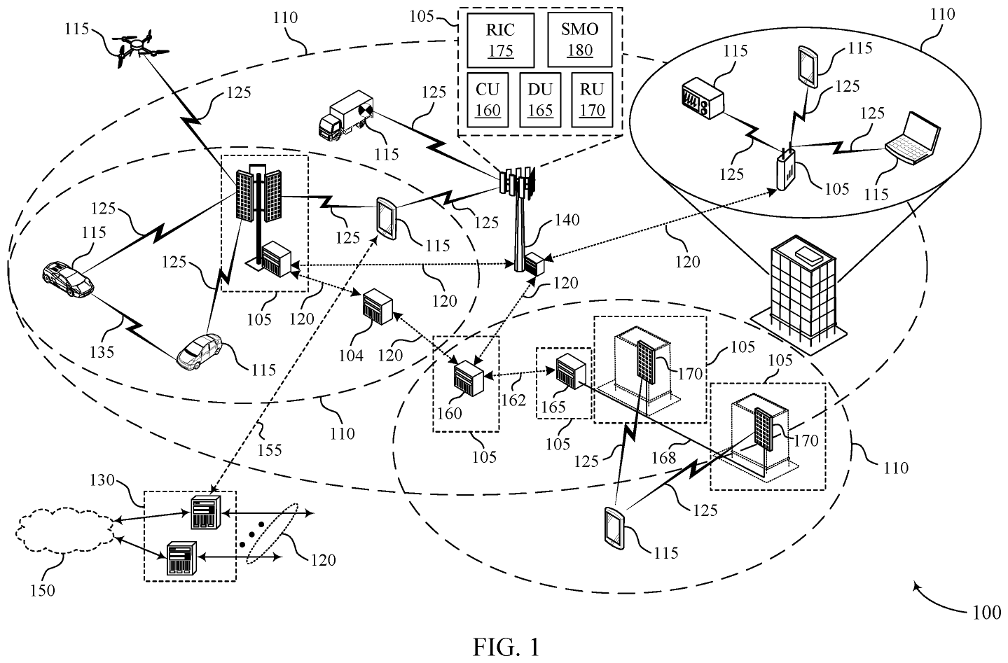

FIG. 1 shows an example of a wireless communications system 100 that supports FD closed loop uplink power control commands in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An TAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support FD closed loop uplink power control commands as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may implement FD communication. For example, a network entity 105 may employ SBFD according to which the network entity 105 may receive via a first set of one or more subbands (which may be referred to as uplink subbands) and transmit via a second set of one or more subbands (which may be referred to as downlink subbands), where the first and second sets of subbands may be non-overlapping in the frequency domain.

Within a carrier, FD time resources (e.g., slots or symbols) may be interspersed with HD resources. A UE 115 may transmit uplink communications to a network entity 105 using a set of open loop and closed loop power control parameters. Open loop parameters may be configured in RRC. Closed loop parameters may be indicated by the network entity 105 in scheduling information for an uplink communication (e.g., a TPC field in a scheduling DCI) or in a DCI format dedicated for providing TPC commands (e.g., DCI format 2_2). For example, in a DCI format 2_2, a particular UE 115 may identify an included TPC command as being for the particular UE 115 based on an RNTI used to scramble the CRC of the DCI.

For example, if a UE 115 transmits a physical uplink control channel (PUCCH) on active uplink BWP b of carrier f in the primary cell c using a PUCCH power control adjustment state with index l, the UE 115 may determine the PUCCH transmission power P_{PUCCH,b,f,c}(i, qᵤ, q_{d}, l) in PUCCH transmission occasion i as in equation 1.

$${P}_{PUCCH , b , f , c} ( i , {q}_{u} , {q}_{d} , l ) = min \{ \begin{matrix}{P}_{CMAX , f , c} ( i ) , \\ \begin{matrix}{P}_{O \_ PUCCH , b , f , c} ( {q}_{u} ) + 10 {log}_{10} ( {2}^{μ} {M}_{RB , f , c}^{PUCCH} ( i ) ) + {PL}_{b , f , c} ( {q}_{d} ) + \\ {Δ}_{F \_ PUCCH} ( F ) + {Δ}_{TF , b , f , c} ( i ) + {g}_{b , f , c} ( i , l )\end{matrix}\end{matrix} dBm \qquad ( 1 )$$

In equation 1, P_{CMAX,f,c}(i) may be the UE 115 configured maximum output power for carrier f. P_{O_PUCCH,b,f,c}(qᵤ) may be an open loop parameter (e.g., P0). For example, P_{O_PUCCH,b,f,c}(qᵤ) may be composed of the sum of a component P_{O_NOMINAL_PUCCH}, provided by p0-nominal, or P_{O_NOMINAL_PUCCH}=0 dBm if p0-nominal is not provided, for carrier f of primary cell c and, if provided, a component P_{O_UE_PUCCH}(qᵤ) provided by p0-PUCCH-Value in P0-PUCCH for active uplink BWP b of carrier f of primary cell c, where 0≤qᵤ<Qᵤ and Qᵤ may be a size for a set of P_{O_UE_PUCCH} values provided by maxNrofPUCCH-P0-PerSet. The set of P_{O_UE_PUCCH} values may be provided by p0-Set. If p0-Set is not provided to the UE 115, P_{O_UE_PUCCH}(qᵤ)=0, and 0≤qᵤ<Qᵤ. If the UE 115 is provided PUCCH-SpatialRelationInfo, the UE 115 may obtain a mapping, by an index provided by p0-PUCCH-Id, between a set of pucch-SpatialRelationInfold values and a set of p0-PUCCH-Value values. If the UE 115 is provided more than one values for pucch-SpatialRelationInfoId and the UE 115 receives an activation command indicating a value of pucch-SpatialRelationInfold, the UE 115 may determine the p0-PUCCH-Value value through the link to a corresponding p0-PUCCH-Id index. The UE 115 may apply the activation command in the first slot that is after slot k+3·Nₛₗₒₜ^{subframe,μ} where k is the slot where the UE 115 would transmit a PUCCH with HARQ-ACK information for the physical downlink shared channel (PDSCH) providing the activation command and μ is the subcarrier spacing (SCS) configuration for the PUCCH. If the UE 115 is not provided PUCCH-SpatialRelationInfo, the UE 115 may obtain the p0-PUCCH-Value value from the P0-PUCCH with p0-PUCCH-Id value equal to the minimum p0-PUCCH-Id value in p0-Set. M_{RB,b,f,c}^{PUCCH}(i) may be a bandwidth of the PUCCH resource assignment expressed in number of resource blocks for PUCCH transmission occasion i on active uplink BWP b of carrier f of primary cell c and μ is a SCS configuration. PL_{b,f,c}(q_{d}) may be a downlink pathloss estimate in dB calculated by the UE 115 using reference signal index q for the active downlink BWP b of carrier f of primary cell c. The parameter Δ_{F_PUCCH}(F) may be a value of deltaF-PUCCH-f0 for PUCCH format 0, deltaF-PUCCH-f1 for PUCCH format 1, deltaF-PUCCH-f2 for PUCCH format 2, deltaF-PUCCH-f3 for PUCCH format 3, and deltaF-PUCCH-f4 for PUCCH format 4, if provided; otherwise Δ_{F_PUCCH}(F)=0. Δ_{TF,b,f,c}(i) may be a PUCCH transmission power adjustment component on active uplink BWP b of carrier f of primary cell c. g_{b,f,c}(i, l) may be the closed loop power control adjustment state indicated by the TPC(s). For the PUCCH power control adjustment state g_{b,f,c}(i, l) for active uplink BWP b of carrier f of primary cell c and PUCCH transmission occasion i, δ_{PUCCH,b,f,c}(i, l) may be a TPC command value included in a DCI format scheduling a PDSCH reception for active UL BWP b of carrier f of the primary cell c that the UE detects for PUCCH transmission occasion i, or may be jointly coded with other TPC commands in a DCI format 2_2 with CRC scrambled by TPC-PUCCH-RNTI. If the UE obtains one TPC command from a DCI format 2_2 with CRC scrambled by a TPC-PUCCH-RNTI, the l value may be provided by the closed loop indicator field in DCI format 2_2. g_{b,f,c}(i, l)=g_{b,f,c}(i−i₀, l)+Σₘ₌₀^{C(C}^{₁}⁾⁻¹ δ_{PUCCH,b,f,c}(m, l) may be the current PUCCH power control adjustment state l. for active uplink BWP b of carrier f of primary cell c and PUCCH transmission occasion i.

As another example, if the UE 115 transmits a physical uplink shared channel (PUSCH) on active uplink BWP b of carrier f in the primary cell c using a PUCCH power control adjustment state with index l, the UE 115 may determine the PUCCH transmission power P_{PUSCH,b,f,c}(i, j, q_{d}, l) in PUCCH transmission occasion i as in equation 2.

$${P}_{PUSCH , b , f , c} ( i , j , {q}_{d} , l ) = min \{ \begin{matrix}{P}_{CMAX , f , c} ( i ) , \\ \begin{matrix}{P}_{O \_ PUSCH , b , f , c} ( j ) + 10 {log}_{10} ( {2}^{μ} {M}_{RB , fb , f , c}^{PUSCH} ( i ) ) + {α}_{b , f , c} ( j ) \cdot \\ {PL}_{b , f , c} ( {q}_{d} ) + {Δ}_{TF , b , f , c} ( i ) + {f}_{b , f , c} ( i , l )\end{matrix}\end{matrix} dBm \qquad ( 2 )$$

In equation 2, P_{CMAX,f,c}(i) may be the UE 115 configured maximum output power for carrier f. P_{O_PUSCH,b,f,c}(j) may be an open loop parameter (e.g., P0). For example, P_{O_PUSCH,b,f,c}(j) may be composed of the sum of a component P_{O_NOMINAL_PUSCH}(j) and a component P_{O_UE_PUSCH,b,f,c}(j) where j∈{0, 1, . . . , j−1}. M_{RB,fb,f,c}^{PUSCH}(i) may be the bandwidth of the PUSCH resource assignment expressed in the number of resource blocks for PUSCH transmission occasion i on active uplink BWP b of carrier f of serving cell C and y is an SCS configuration. PL_{b,f,c}(q_{d}) may be a downlink pathloss estimate in dB calculated by the UE 115 using reference signal index q for the active downlink BWP b of carrier f of primary cell c. Δ_{TF,b,f,c}(i) may be a parameter determined based on the modulation and coding scheme (MCS). For example, Δ_{TF,b,f,c}(i)=10 log₁₀((2^{BPRE·k}^{ₛ}−1)β_{offset}^{PUSCH}) for kₛ=1.25 and Δ_{TF,b,f,c}(i)=0 for kₛ=0 where kₛ is provided by deltaMCS for each uplink BWP b of carrier f of serving cell C. If a PUSCH transmission is over more than one layer, Δ_{TF,b,f,c}(i)=0. β_{offset}^{PUSCH}=1 when the PUSCH includes uplink shared channel data and β_{offset}^{PUSCH}=β_{offset}^{CSI,1} when the PUSCH includes CSI and does not include uplink shared channel data.

$$B P R E = {\sum }_{r = 0}^{C - 1} \frac{{K}_{r}}{{N}_{R E}}$$

for a PUSCH with uplink shared channel data and

$$BPRE = {Q}_{m} \cdot \frac{R}{{β}_{o f f s e t}^{P U S C H}}$$

for CSI transmission in a PUSCH without uplink shared channel data, where C is a number of transmitted code blocks, K_{T} is a size for code block r, and N_{RE} is a number of resource elements determined as

$${N}_{R E} = {M}_{RB , b , f , c}^{P U S C H} ( i ) \cdot {\sum }_{j = 0}^{{N}_{symb , b , f , c}^{P U S C H} ( 1 ) - 1} {N}_{sc , data}^{R B} ( i , j ) ,$$

where N_{symb,b,f,c}^{PUSCH}(i) may be a number of symbols for PUSCH transmission occasion i on active UL BWP b of carrier f of serving cell C, N_{sc,data}^{RB}(i, j) may be a number of subcarriers excluding demodulation reference signal (DMRS) subcarriers and phase-tracking reference signal samples in the PUSCH symbol j and assuming no segmentation for a nominal repetition in case the PUSCH transmission is with repetition Type B, 0≤j<N_{symb,b,f,c}^{PUSCH}(i). Qₘ may be the modulation order and R may be the target code rate. f_{b,f,c}(i, l) may be the closed loop power control adjustment state indicated by the TPC(s). For the PUSCH power control adjustment state f_{b,f,c}(i, l) for active uplink BWP b of carrier f of primary cell c and PUCCH transmission occasion i, δ_{PUSCH,b,f,c}(i, l) may be a TPC command value included in a DCI format scheduling a PDSCH reception for active UL BWP b of carrier f of the primary cell c that the UE detects for PUCCH transmission occasion i, or may be jointly coded with other TPC commands in a DCI format 2_2 with CRC scrambled by TPC-PUSCH-RNTI. If the UE obtains one TPC command from a DCI format 2_2 with CRC scrambled by a TPC-PUSCH-RNTI, the l value may be provided by the closed loop indicator field in DCI format 2_2. f_{b,f,c}(i, l)=f_{b,f,c}(i−i₀, l)+Σₘ₌₀^{C(D}^{ᵢ}⁾⁻¹δ_{PUSCH,b,f,c}(m, l) may be the current PUSCH power control adjustment state 1. for active uplink BWP b of carrier f of primary cell c and PUCCH transmission occasion i, where Σₘ₌₀^{C(D}^{ᵢ}⁾⁻¹δ_{PUSCH,b,f,c}(m, l) may be a sum of TPC command values in a set Dᵢ of TPC command values with cardinality C(Dᵢ) that the UE receives between K_{PUSCH}−(i−i₀)−1 symbols before PUSCH transmission occasion i−i₀ and K_{PUSCH}(i) symbols before PUSCH transmission occasion i on active UL BWP b of carrier f of serving cell C for PUSCH power control adjustment state l, where i₀>0 is the smallest integer for which K_{PUSCH}(i−i₀) symbols before PUSCH transmission occasion i−i₀ is earlier than K_{PUSCH}(i) symbols before PUSCH transmission occasion i. If a PUSCH transmission is scheduled by a DCI format, K_{PUSCH}(i) is a number of symbols for active uplink BWP b of carrier f of serving cell C after a last symbol of a corresponding PDCCH reception and before a first symbol of the PUSCH transmission. If a PUSCH transmission is configured by ConfiguredGrantConfig, K_{PUSCH}(i) is a number of K_{PUSCH,min} symbols equal to the product of a number of symbols per slot, N_{symb}^{slot}, and the minimum of the values provided by k2 in PUSCH-ConfigCommon for active uplink BWP b of carrier f of serving cell C. If the UE has reached maximum power for active BWP b of carrier f of serving cell C at PUSCH transmission occasion i−i₀ and Σₘ₌₀^{C(D}^{ᵢ}⁾⁻¹ δ_{PUSCH,b,f,c}(m, l)≥0, then f_{b,f,c}(i, l)=f_{b,f,c}(i−i₀, l). If the UE has reached minimum power for active BWP b of carrier f of serving cell C at PUSCH transmission occasion i−i₀ and Σₘ₌₀^{C(D}^{ᵢ}⁾⁻¹ δ_{PUSCH,b,f,c}(m, l)≤0, then f_{b,f,c}(i, l) f_{b,f,c}(i−i₀, l). A UE resets accumulation of a PUSCH power control adjustment state 1. for active UL BWP b of carrier f of serving cell C to f_{b,f,c}(k, l)=0, k=0, 1, . . . , i if a configuration for a corresponding P_{O_UE_PUSCH,b,f,c}(j) value may be provided by higher layers or if a configuration for a corresponding α_{b,f,c}(j) value may be provided by higher layers.

A UE 115 may maintain multiple uplink power states which may accumulate closed loop TPC commands and/or may be adjusted based on closed loop TPC commands and the UE 115 may determine the total uplink transmit power based on the power states. As transmissions in FD and HD time resources may cause differing amounts of CLI and self-interference, a network entity 105 may transmit separate closed loop FD TPC commands and HD TPC commands for a UE 115 via DCI. (e.g., either via scheduling DCI or a dedicated DCI such as a DCI format 2_2). The DCI or reception of the DCI may indicate whether the TPC command is an HD type TPC command or an FD type TPC command. For example, the UE 115 may identify whether a DCI format 2_2 includes an HD type TPC command or an FD type TPC command based on whether the DCI format 2_2 is scrambled with a RNTI (e.g., a PUSCH RNTI, a PUCCH RNTI, or a sounding reference signal (SRS) RNTI) associated with HD type TPC commands or FD type TPC commands. As another example, each DCI format 2_2 may include an HD type TPC command and an FD type TPC command, and the UE 115 may identify the HD and FD type TPC commands based on the relative locations within the DCI. As another example, a new DCI format may be defined for providing FD TPC commands. As another example, for a scheduling DCI, the UE 115 may identify whether the TPC command is for an HD type TPC command or an FD type TPC command based on whether the DCI schedules an uplink communication in an FD or HD type slot. The network may configure different closed loop power control states (e.g., accumulators) for HD and FD, and the UE may apply a TPC command to an HD or FD closed loop power control state based on whether the TPC command is an HD type TPC command or an FD type TPC command.

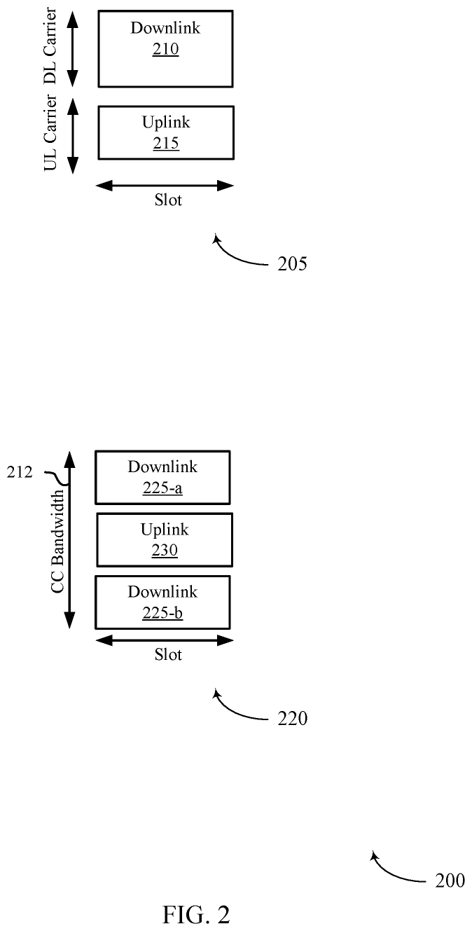

FIG. 2 shows an example of a resource diagram 200 that supports FD closed loop uplink power control commands in accordance with one or more aspects of the present disclosure. The resource diagram 200 may implement aspects of the wireless communications system 100.

As described herein, some wireless communications systems may implement FD communications. FD communications may be in-band FD (IBFD) communications or SBFD communications (e.g., flexible duplex). For example, a network entity 105 may use FD communications for MU-MIMO applications.

A first example 205 illustrates an example FD scenario with one downlink carrier 210 and one uplink carrier 215. For example, the first example illustrates a carrier aggregation based FD scenario. A second example 220 illustrates an example SBFD slot with a first downlink subband 225-a, a second downlink subband 225-b, and an uplink subband 230 positioned between the first downlink subband 225-a and the second downlink subband 225-b in frequency. The first downlink subband 225-a, the second downlink subband 225-b, and the uplink subband 230 may be within a same single component carrier 212. As shown in the second example 220, the downlink subbands 225 and uplink subband 230 may be separated in frequency by guard bands. Although the uplink subband 230 is shown between downlink subbands 225, the uplink and downlink subbands may be arranged in any order.

Implementation of FD communications may increase uplink duty cycle, leading to latency reduction. For example, in an SBFD example, it is possible for a UE 115 to transmit an uplink signal in the uplink subband 230 of a legacy downlink slot (if SBFD is configured for the legacy downlink slot) or a flexible slot, or for a UE 115 to receive a downlink transmission in the downlink subband 225 in a legacy uplink slot (if SBFD is configured for the legacy uplink slot), which may reduce latency as the UE 115 may not wait for an uplink slot to transmit an uplink transmission or a downlink slot to receive a downlink transmission. Additionally, or alternatively, implementation of FD communications may enhance system capacity, resource utilization, and/or spectrum efficiency. Additionally, or alternatively, implementation of FD communications may enable flexible and dynamic uplink and downlink resource adaption according to uplink and downlink traffic conditions.

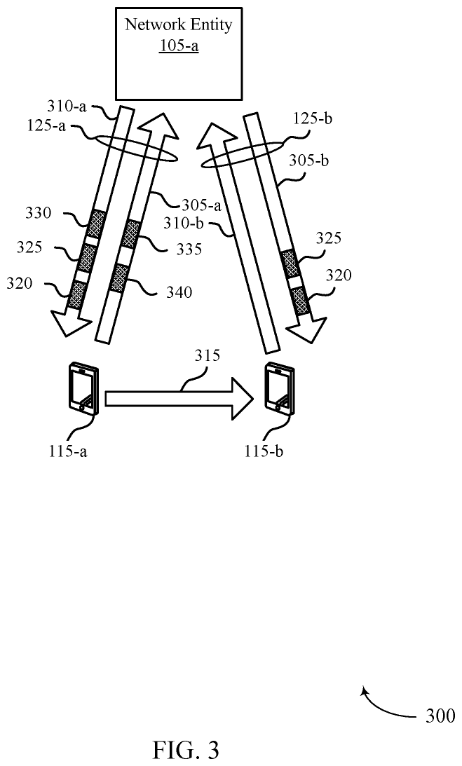

FIG. 3 shows an example of a wireless communications system 300 that supports FD closed loop uplink power control commands in accordance with one or more aspects of the present disclosure. The wireless communications system 300 may implement aspects of the wireless communications system 100 or the resource diagram 200. For example, the wireless communications system 300 may include a UE 115-a and a UE 115-b, which may be examples of a UE 115 as described herein. The wireless communications system 300 may include a network entity 105-a, which may be an example of a network entity 105 as described herein.

The UE 115-a may communicate with the network entity 105-a using a communication link 125-a, and the UE 115-b may communicate with the network entity 105-a using a communication link 125-b. The communication link 125-a may be an example of an NR or LTE link between the UE 115-a and the network entity 105-a. The communication link 125-b may be an example of an NR or LTE link between the UE 115-b and the network entity 105-a. The communication link 125-a and the communication link 125-b may include bi-directional links that enable both uplink and downlink communications. For example, the UE 115-a may transmit uplink signals 305-a (e.g., uplink transmissions), such as uplink control signals or uplink data signals, to the network entity 105-a using the communication link 125-a and the network entity 105-a may transmit downlink signals 310-a (e.g., downlink transmissions), such as downlink control signals or downlink data signals, to the UE 115-a using the communication link 125-a. The UE 115-b may transmit uplink signals 305-b (e.g., uplink transmissions), such as uplink control signals or uplink data signals, to the network entity 105-a using the communication link 125-b and the network entity 105-a may transmit downlink signals 310-b (e.g., downlink transmissions), such as downlink control signals or downlink data signals, to the UE 115-b using the communication link 125-b.

The network entity 105-a may implement FD communications. For example, the network entity 105-a may communicate with the UE 115-a and the UE 115-b using SBFD. For example, the network entity 105-a may receive an uplink signal 305-a from the UE 115-a in an uplink subband of a same time resource that the network entity 105-a transmits a downlink signal 310-b via one or more downlink subbands to the UE 115-b. The transmission of the uplink signal 305-a may cause CLI 315 to the UE 115 b with regard to reception of the downlink signal 310-b in the same time resource. Similarly, UEs 115 may suffer from CLI caused by UEs 115 in other cells (e.g., served by other network entities 105). Further, misaligned TDD schemes between different network entities 105 may cause inter-cell CLI. Accordingly, CLI may be different in FD and TD time resources. To adjust for different CLI conditions in FD and TD time resources, the network entity 105-a may transmit separate closed loop FD TPC commands and HD TPC commands for a UE 115.

For example, the network entity 105-a may transmit control signaling 320 (e.g., RRC or system information) to the UE 115-a and/or the UE 115-b indicating a set of HD time resources and a set of FD time resources. For example, the HD time resources and a set of FD time resources may be slots or symbols. The HD time resources and the FD time resources may be interspersed with each other.

The network entity 105-a may transmit a DCI 325 to the UE 115-a that indicates an FD type uplink TPC. The DCI 325 or receipt of the DCI 325 may indicate that the uplink TPC is an FD type uplink TPC. The UE 115-a may transmit an uplink communication 335 (e.g., an SRS, a PUCCH, or a PUSCH) in an FD time resource of the set of FD time resources in accordance with the FD type uplink TPC indicated in the DCI 325.

For example, if the DCI 325 is a DCI dedicated for providing TPC commands (e.g., a DCI format 2_2), different RNTIs may be used to indicate whether the TPC is an FD type TPC or an HD type TPC. For example, DC format 2_2 may be a group common DCI, and accordingly, if the DCI 325 is a DCI format 2_2, the network entity 105-a may transmit the DCI 325 to the UE 115-a and the UE 115-b and/or one or more other UEs. The network entity 105-a may scramble the CRC of the payload the DCI 325 of the DCI format 2_2 intended for a given UE 115 with an RNTI for that given UE 115. UEs 115 may have separate RNTIs for SRS, PUSCH, and PUCCH TPCs, and similarly, UEs 115 may have separate RNTIs for FD type TPCs and HD type TPCs. For example, the UE 115-a may determine that a TPC in the DCI 325 is an FD type TPC for the UE 115-a based on the CRC being scrambled with an FD RNTI for the UE 115-a. In some examples, the UE 115-a may be configured with an HD SRS RNTI, an HD PUSCH RNTI, an HD PUCCH RNTI, an FD SRS RNTI, an FD PUSCH RNTI, and an FD PUCCH RNTI. In some examples, the HD and FD RNTIs may be indicated to the UE 115-a in the control signaling 320 (which may be the same control message or a different control message as the control message that indicates the set of HD time resources and the set of FD time resources). In some examples, the UE 115-a may determine or derive the FD RNTI(s) from the HD RNTI(s).

In some examples, the DCI 325 may have a new format (e.g., different from DCI format 2_2) to indicate FD type TPC commands. If the DCI 325 has the new format, the UE 115-a may determine that the TPC included in the DCI 325 for the UE 115-a is a FD type TPC command based on the format of the DCI. Similarly, the UE 115-a may determine a TPC command is an HD type TPC command based on a format of a DCI for carrying HD type TPC commands.

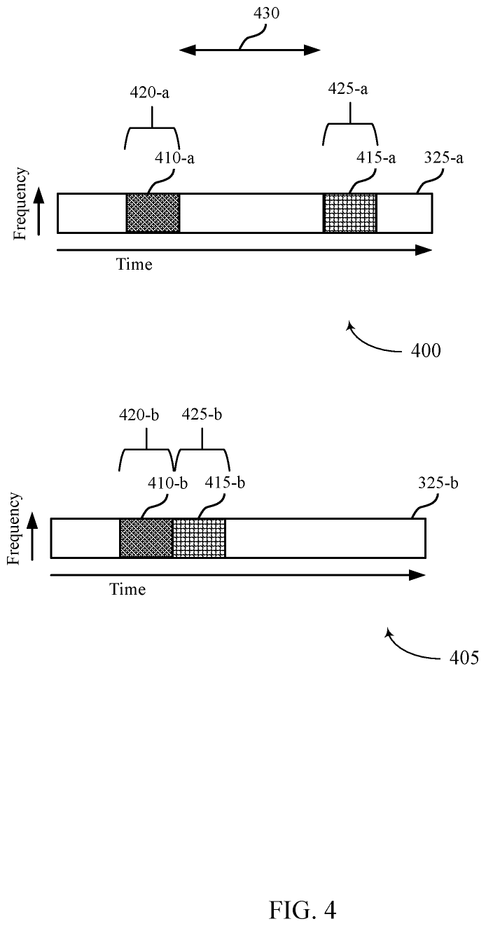

In some examples, as described with reference to FIG. 4, the DCI 325 may be dedicated for providing TPC commands (e.g., a DCI format 2_2) and may include both an FD type TPC command and an HD type TPC command. The UE 115-a may identify which TPC command is the FD type TPC command and which TPC command is the HD type TPC command based on the location of the TPC commands within the DCI 325. For example, the UE 115-a may transmit the uplink communication 335 (e.g., an SRS, a PUCCH, or a PUSCH) in an FD time resource of the set of FD time resources in accordance with the FD type uplink TPC indicated in the DCI 325 and the UE 115-b may transmit an uplink communication 340 (e.g., an SRS, a PUCCH, or a PUSCH) in an HD time resource of the set of HD time resources in accordance with the HD type uplink TPC indicated in the DCI 325.

In some examples, the DCI 325 may be a scheduling DCI. For example, the DCI 325 may schedule the uplink communication 335. The UE 115-a may identify that the TPC command in the DCI 325 is an FD type TPC command based on the DCI 325 scheduling the uplink communication 335 in an FD time resource. Similarly, the UE 115-a may receive a DCI 330 that schedules the uplink communication 340 in an HD time resource of the set of HD time resources, and the UE 115-a may identify that the TPC command in the DCI 330 is an HD type TPC command based on the DCI 330 scheduling the uplink communication 340 in an HD time resource. In some examples, the DCI (e.g., the DCI 325 and the DCI 330) may include a field indicating whether a TPC command in the DCI is an FD type TPC command or an HD type TPC command.

In some examples, a DCI may schedule multiple PUSCH transmissions. For example, the DCI 325 may schedule the uplink communication 335 and the uplink communication 340. In some examples, the UE 115-a may identify whether the TPC command in a DCI is an FD type TPC command or an HD type TPC command based on whether the temporally first PUSCH transmission in the multiple PUSCH transmissions is scheduled in an FD time resource or an HD time resource. In some examples, if the set of multiple PUSCH transmissions includes both HD and FD time resources, the UE 115-a may apply the TPC command to both FD and HD closed loop power control states.

As described herein, a UE 115-a may maintain multiple closed loop power control states. Closed loop power control states may accumulate TPC commands. Closed loop power control states may be configured in the control signaling 320 (e.g., in a same control message or a different control message as the control message that indicates the set of HD time resources and the set of FD time resources). In some examples, the UE 115-a may be configured with separate FD and HD closed loop power control states (e.g., accumulators), and HD type TPC commands may be applied to the HD closed loop power control state and FD type TPC commands may be applied to the FD closed loop power control state. For example, the UE 115-a may transmit an uplink communication 335 in an FD time resource in accordance with the FD closed loop power control state and the UE 115-a may transmit an uplink communication 340 in an HD time resource in accordance with the HD closed loop power control state. In some examples, the UE 115-a may be configured with multiple HD closed loop power control states and multiple FD closed loop power control states (for example, for application for different beams). DCI (e.g., the DCI 325 and the DCI 330) may indicate to which of the multiple FD closed loop power control states and multiple HD closed loop power control states a given TPC command is applicable. In some examples, whether a closed loop power control state is associated with HD or FD may be updated dynamically (e.g., via DCI or via a MAC control element (MAC-CE)).

FIG. 4 shows an example diagram 400 of DCI 325-a and an example diagram 405 of DCI 325-b that supports FD closed loop uplink power control commands in accordance with one or more aspects of the present disclosure. The example diagram 400 of DCI 325-a and an example diagram 405 of DCI 325-b may implement aspects of the wireless communications system 100, the resource diagram 200, or the wireless communications system 300. For example, the DCI 325-a and the DCI 325-b may be examples of a DCI 325 as described herein. For example, the DCI 325-a may be a DCI format 2_2.

As described herein, a DCI 325 may include both an HD type TPC command 410 and an FD type TPC command 415. For example, the DCI 325-a may include an HD type TPC command 410-a at a location 420-a and an FD type TPC command 415-a at a location 425-a. For example, the location 420-a and the location 425-a may be given symbols within the DCI 325-a. As another example, the DCI 325-b may include an HD type TPC command 410-b at a location 420-b and an FD type TPC command 415-b at a location 425-b.

In some examples, such as in the example diagram 400, the location 420-a for the HD type TPC command 410-a and the location 425-a for the FD type TPC command 415-a may be configured (e.g., in control signaling such as RRC) or may be standardized or pre-defined for the DCI format of the DCI 325-a. In some examples, the location 425-a for the FD type TPC command 415-a may be a configured offset 430 from the location 420-a for the HD type TPC command 410-a. For example, with a configured offset 430, a given UE 115 may identify that the HD type TPC command 410-a is intended for the given UE 115 based on the CRC of the HD type TPC command 410-a being scrambled with the RNTI for the given UE 115, and the UE 115-a may identify the location 425-a for the FD type TPC command 415-a based on the configured offset 430. For example, the configured offset 430 may be a quantity of symbols.

In some examples, such as in the example diagram 405, the location 420-a for the HD type TPC command 410-b and the location 425-b for the FD type TPC command 415-b may be adjacent or consecutive. For example, a given UE 115 may identify that the HD type TPC command 410-b is intended for the given UE 115 based on the CRC of the HD type TPC command 410-b being scrambled with the RNTI for the given UE 115, and the given UE 115 may identify the next location in the DCI (e.g., the location 425-b) as including an FD type TPC command 415-b for the given UE 115.

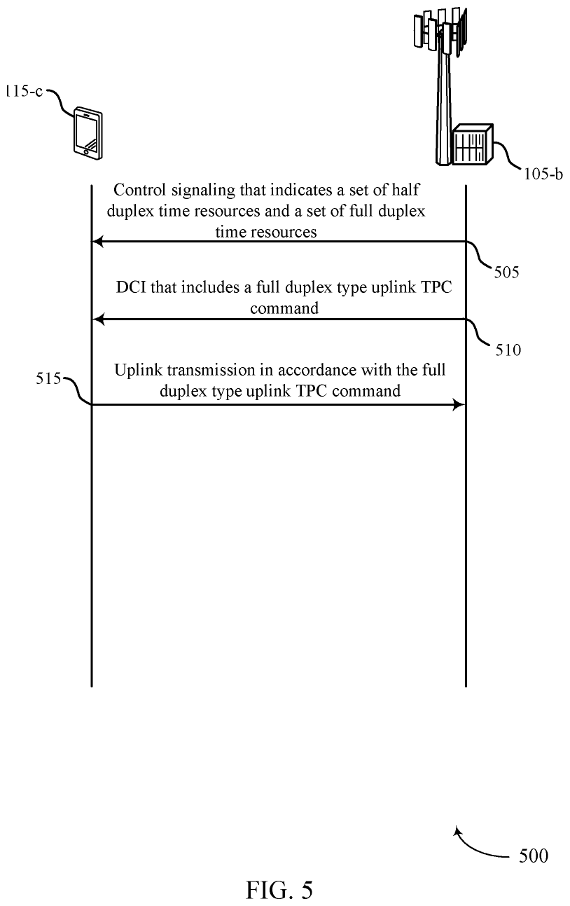

FIG. 5 shows an example of a process flow 500 that supports FD closed loop uplink power control commands in accordance with one or more aspects of the present disclosure. The process flow 500 may include a UE 115-c, which may be an example of a UE 115 as described herein. The process flow 500 may include a network entity 105-b, which may be an example of a network entity 105 as described herein. In the following description of the process flow 500, the operations between the network entity 105-b and the UE 115-c may be transmitted in a different order than the example order shown, or the operations performed by the network entity 105-b and the UE 115-c may be performed in different orders or at different times. Some operations may also be omitted from the process flow 500, and other operations may be added to the process flow 500.

At 505, the UE 115-c may receive, from the network entity 105-b, control signaling that indicates a set of HD time resources and a set of FD time resources.

At 510, the UE 115-c may receive, from the network entity 105-b, DCI that includes an uplink TPC command. The DCI or receipt of the DCI may be indicative of the uplink TPC command being an FD type uplink TPC command.

At 515, the UE 115-c may transmit, to the network entity 105-b, an uplink communication in a time resource of the set of FD time resources in accordance with the uplink TPC command. For example, the uplink communication may be a PUSCH, a PUCCH, or an SRS.

In some examples, the DCI may be scrambled by an RNTI for the UE 115-c associated with the set of FD time resources, and the DCI may be indicative of the uplink TPC command being the FD type uplink TPC command based on the DCI being scrambled by the RNTI associated with the set of FD time resources. In some examples, the UE 115-c may receive, from the network entity 105-b via the control signaling or via second control signaling, an indication of the RNTI for the UE 115-c. In some examples, the UE 115-c may receive, from the network entity 105-b via the control signaling or via second control signaling, an indication of a second RNTI for the UE 115-c associated with the set of HD time resources, and the UE 115-c may determine the RNTI for the UE 115-c associated with the set of FD time resources based on the second RNTI (e.g., the RNTI for the UE 115-c associated with the set of FD time resources may be derived from the second RNTI associated with the set of HD time resources).

In some examples, the DCI may have a format associated with the set of FD time resources, and the DCI may be indicative of the uplink TPC command being the FD type uplink TPC command based on the format.

In some examples, the DCI may include a second uplink TPC command of an HD type uplink TPC command, and the DCI may be indicative of the uplink TPC command being the FD type uplink TPC command based on a location of the uplink TPC command within the DCI. In some examples, the UE 115-c may receive, from the network entity 105-b via the control signaling or via second control signaling, an indication of a first location within a DCI format associated with FD type uplink TPC commands and a second location within the DCI format associated with HD type uplink TPC commands, the DCI has the DCI format, the location is the first location, and the second uplink TPC command is within the second location. In some examples, the location is adjacent to a second location of the second uplink TPC command. In some examples, the location is a configured offset from a second location of the second uplink TPC command.

In some examples, the DCI may schedule the uplink communication in the time resource, and the receipt of the DCI may be indicative of the uplink TPC command being the FD type uplink TPC command based on the time resource being an FD time resource.

In some examples, the DCI may include a field indicating that the uplink TPC command is the FD type uplink TPC command.

In some examples, the UE 115-c may receive, from the network entity 105-b via the control signaling or via second control signaling, an indication that a first uplink TPC command accumulator (e.g., closed loop uplink power control state) is associated with FD type uplink TPC commands and a second uplink TPC command accumulator is associated with HD type uplink TPC commands, where the uplink TPC command is applied to the first uplink TPC command accumulator based on the uplink TPC command being the FD type uplink TPC command, and where the uplink communication is transmitted in accordance with the first uplink TPC command accumulator. In some examples, the UE 115-c may receive, from the network entity 105-b, second DCI that includes a second uplink TPC command, where the second DCI or receipt of the second DCI may be indicative of the second uplink TPC command being an HD type uplink TPC command, and where the second uplink TPC command is applied to the second uplink TPC command accumulator based on the second uplink TPC command being the HD type uplink TPC command. In such examples, the UE 115-c may transmit, to the network entity 105-b, a second uplink communication in a second time resource of the set of HD time resources in accordance with the second uplink TPC command accumulator. In some examples, the UE 115-c may receive, from the network entity 105-b via the control signaling or via the second control signaling, an indication that a third uplink TPC command accumulator is associated with the FD type uplink TPC commands and that a fourth uplink TPC command accumulator is associated with the HD type uplink TPC commands.

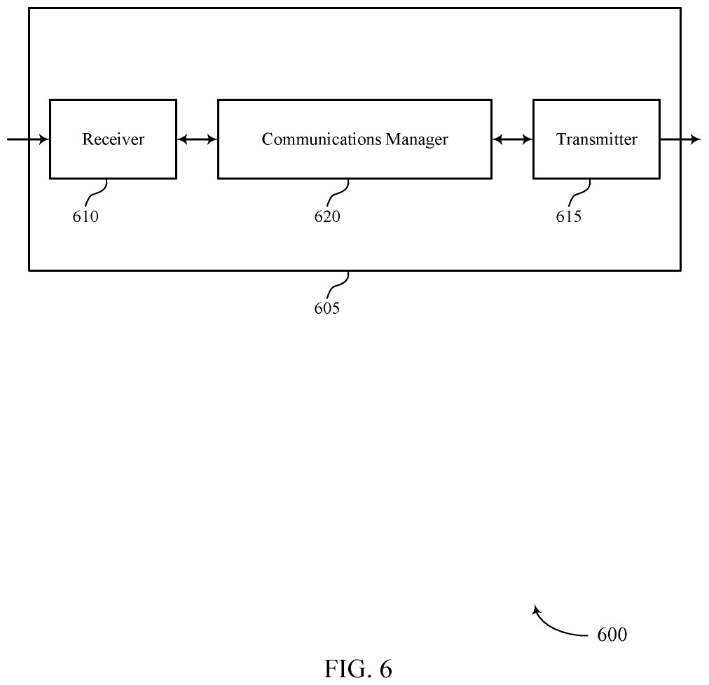

FIG. 6 shows a block diagram 600 of a device 605 that supports FD closed loop uplink power control commands in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to FD closed loop uplink power control commands). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to FD closed loop uplink power control commands). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of FD closed loop uplink power control commands as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving control signaling that indicates a set of HD time resources and a set of FD time resources. The communications manager 620 is capable of, configured to, or operable to support a means for receiving DCI that includes an uplink TPC command, where the DCI or receipt of the DCI is indicative of the uplink TPC command being an FD type uplink TPC command. The communications manager 620 is capable of, configured to, or operable to support a means for transmitting an uplink communication in a time resource of the set of FD time resources in accordance with the uplink TPC command.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for more efficient utilization of communication resources.

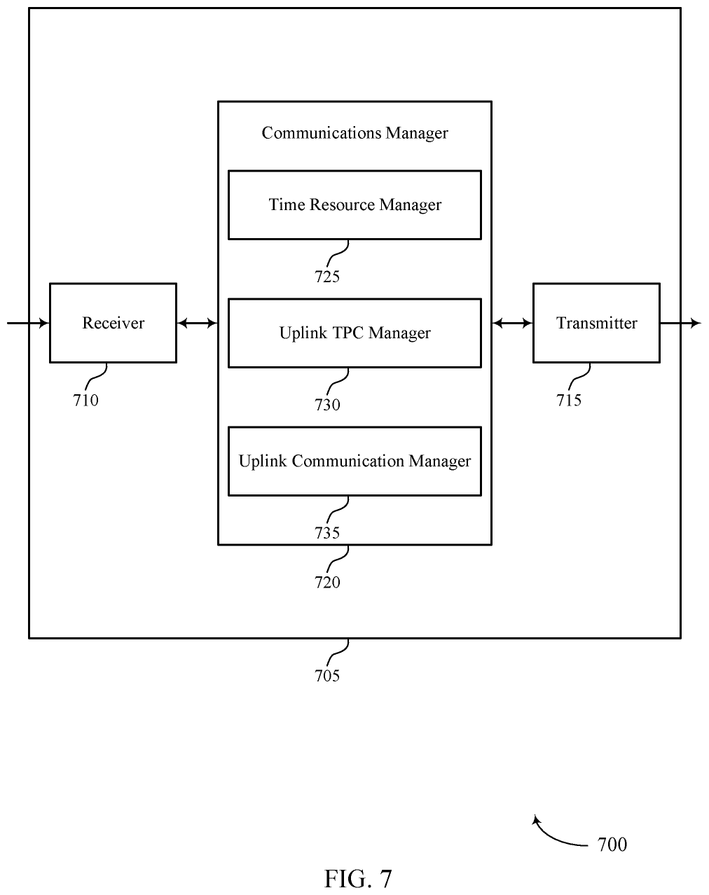

FIG. 7 shows a block diagram 700 of a device 705 that supports FD closed loop uplink power control commands in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to FD closed loop uplink power control commands). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to FD closed loop uplink power control commands). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of FD closed loop uplink power control commands as described herein. For example, the communications manager 720 may include a time resource manager 725, an uplink TPC manager 730, an uplink communication manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The time resource manager 725 is capable of, configured to, or operable to support a means for receiving control signaling that indicates a set of HD time resources and a set of FD time resources. The uplink TPC manager 730 is capable of, configured to, or operable to support a means for receiving DCI that includes an uplink TPC command, where the DCI or receipt of the DCI is indicative of the uplink TPC command being an FD type uplink TPC command. The uplink communication manager 735 is capable of, configured to, or operable to support a means for transmitting an uplink communication in a time resource of the set of FD time resources in accordance with the uplink TPC command.

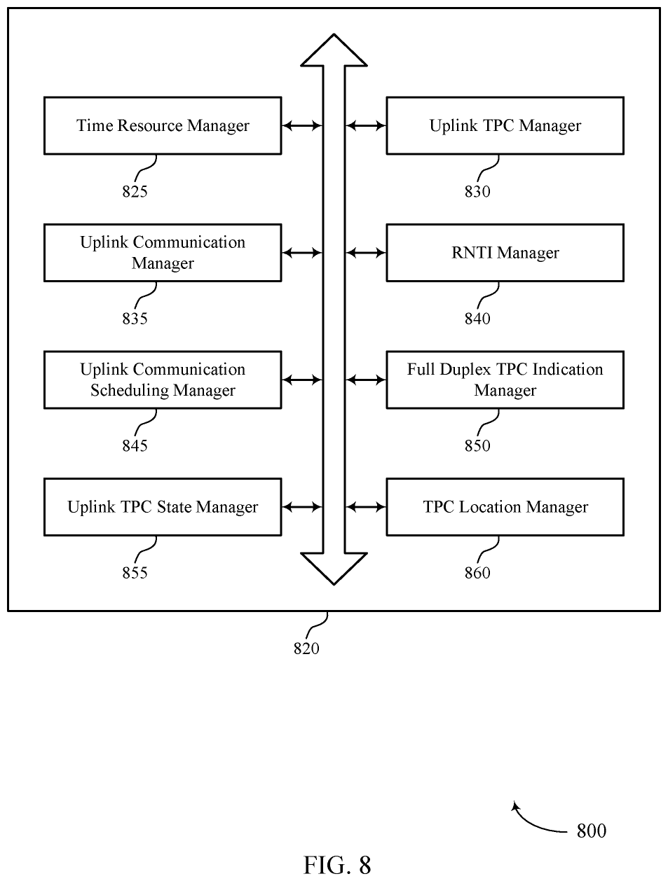

FIG. 8 shows a block diagram 800 of a communications manager 820 that supports FD closed loop uplink power control commands in accordance with one or more aspects of the present disclosure. The communications manager 820 may be an example of aspects of a communications manager 620, a communications manager 720, or both, as described herein. The communications manager 820, or various components thereof, may be an example of means for performing various aspects of FD closed loop uplink power control commands as described herein. For example, the communications manager 820 may include a time resource manager 825, an uplink TPC manager 830, an uplink communication manager 835, an RNTI manager 840, an uplink communication scheduling manager 845, an FD TPC indication manager 850, an uplink TPC state manager 855, a TPC location manager 860, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The time resource manager 825 is capable of, configured to, or operable to support a means for receiving control signaling that indicates a set of HD time resources and a set of FD time resources. The uplink TPC manager 830 is capable of, configured to, or operable to support a means for receiving DCI that includes an uplink TPC command, where the DCI or receipt of the DCI is indicative of the uplink TPC command being an FD type uplink TPC command. The uplink communication manager 835 is capable of, configured to, or operable to support a means for transmitting an uplink communication in a time resource of the set of FD time resources in accordance with the uplink TPC command.

In some examples, to support receiving the DCI, the RNTI manager 840 is capable of, configured to, or operable to support a means for receiving the DCI scrambled by a RNTI for the UE associated with the set of FD time resources; where the DCI is indicative of the uplink TPC command being the FD type uplink TPC command based on the DCI being scrambled by the RNTI associated with the set of FD time resources.

In some examples, the RNTI manager 840 is capable of, configured to, or operable to support a means for receiving, via the control signaling or via second control signaling, an indication of the RNTI for the UE.

In some examples, the RNTI manager 840 is capable of, configured to, or operable to support a means for receiving, via the control signaling or via second control signaling, an indication of a second RNTI for the UE associated with the set of HD time resources. In some examples, the RNTI manager 840 is capable of, configured to, or operable to support a means for determining the RNTI for the UE based on the second RNTI.

In some examples, the DCI has a format associated with the set of FD time resources. In some examples, the DCI is indicative of the uplink TPC command being the FD type uplink TPC command based on the format.

In some examples, to support receiving the DCI, the uplink TPC manager 830 is capable of, configured to, or operable to support a means for receiving the DCI that includes a second uplink TPC command of an HD type uplink TPC command, where the DCI is indicative of the uplink TPC command being the FD type uplink TPC command based on a location of the uplink TPC command within the DCI.

In some examples, the TPC location manager 860 is capable of, configured to, or operable to support a means for receiving, via the control signaling or via second control signaling, an indication of a first location within a DCI format associated with FD type uplink TPC commands and a second location within the DCI format associated with HD type uplink TPC commands, where the DCI has the DCI format, where the location is the first location, and where the second uplink TPC command is within the second location.

In some examples, the location is adjacent to a second location of the second uplink TPC command.

In some examples, the location is a configured offset from a second location of the second uplink TPC command.

In some examples, to support receiving the DCI, the uplink communication scheduling manager 845 is capable of, configured to, or operable to support a means for receiving the DCI scheduling the uplink communication in the time resource, where the receipt of the DCI is indicative of the uplink TPC command being the FD type uplink TPC command based on the time resource being an FD time resource.

In some examples, to support receiving the DCI, the FD TPC indication manager 850 is capable of, configured to, or operable to support a means for receiving the DCI that includes a field indicating that the uplink TPC command is the FD type uplink TPC command.

In some examples, the uplink TPC state manager 855 is capable of, configured to, or operable to support a means for receiving, via the control signaling or via second control signaling, an indication that a first uplink TPC command accumulator is associated with FD type uplink TPC commands and a second uplink TPC command accumulator is associated with HD type uplink TPC commands, where the uplink TPC command is applied to the first uplink TPC command accumulator based on the uplink TPC command being the FD type uplink TPC command, and where the uplink communication is transmitted in accordance with the first uplink TPC command accumulator.

In some examples, the uplink TPC manager 830 is capable of, configured to, or operable to support a means for receiving second DCI that includes a second uplink TPC command, where the second DCI or receipt of the second DCI is indicative of the second uplink TPC command being an HD type uplink TPC command, and where the second uplink TPC command is applied to the second uplink TPC command accumulator based on the second uplink TPC command being the HD type uplink TPC command. In some examples, the uplink communication manager 835 is capable of, configured to, or operable to support a means for transmitting a second uplink communication in a second time resource of the set of HD time resources in accordance with the second uplink TPC command accumulator.

In some examples, the uplink TPC state manager 855 is capable of, configured to, or operable to support a means for receiving, via the control signaling or via the second control signaling, an indication that a third uplink TPC command accumulator is associated with the FD type uplink TPC commands and that a fourth uplink TPC command accumulator is associated with the HD type uplink TPC commands.

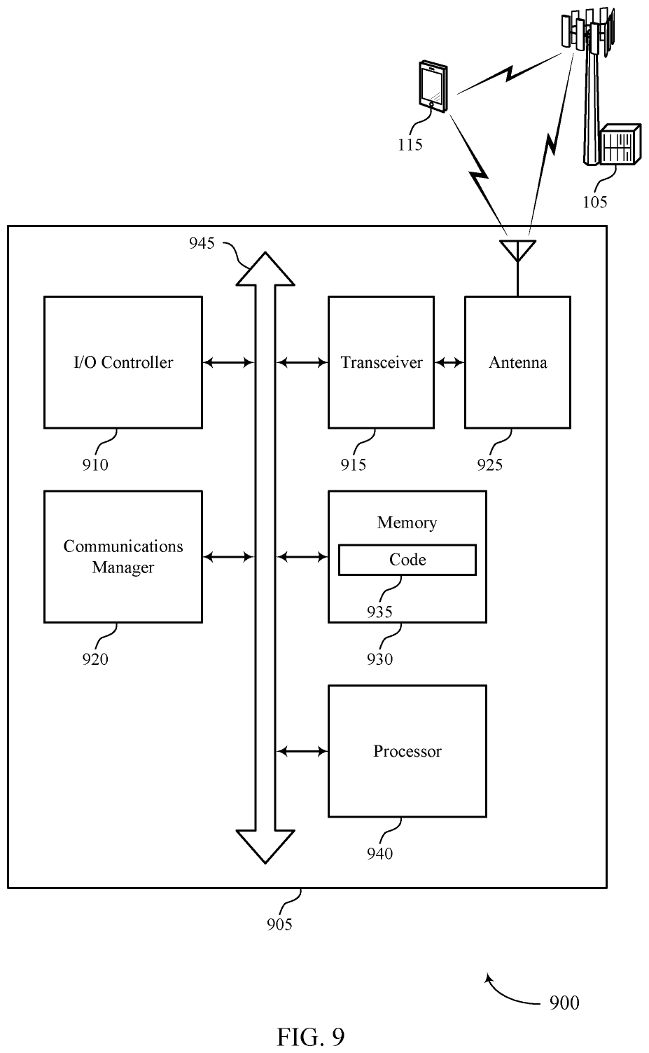

FIG. 9 shows a diagram of a system 900 including a device 905 that supports FD closed loop uplink power control commands in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting FD closed loop uplink power control commands). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving control signaling that indicates a set of HD time resources and a set of FD time resources. The communications manager 920 is capable of, configured to, or operable to support a means for receiving DCI that includes an uplink TPC command, where the DCI or receipt of the DCI is indicative of the uplink TPC command being an FD type uplink TPC command. The communications manager 920 is capable of, configured to, or operable to support a means for transmitting an uplink communication in a time resource of the set of FD time resources in accordance with the uplink TPC command.

By including or configuring the communications manager 920 in accordance with examples as described herein, the device 905 may support techniques for improved communication reliability, reduced latency, more efficient utilization of communication resources, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of FD closed loop uplink power control commands as described herein, or the at least one processor 940 and the at least one memory 930 may be otherwise configured to, individually or collectively, perform or support such operations.

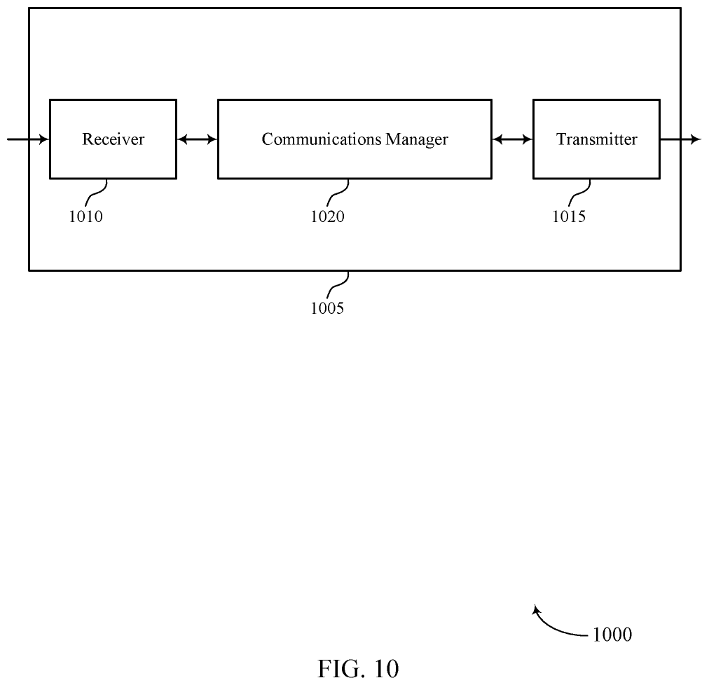

FIG. 10 shows a block diagram 1000 of a device 1005 that supports FD closed loop uplink power control commands in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of FD closed loop uplink power control commands as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting, to a UE, control signaling that indicates a set of HD time resources and a set of FD time resources. The communications manager 1020 is capable of, configured to, or operable to support a means for outputting, to the UE, DCI that includes an uplink TPC command, where the DCI or transmission of the DCI is indicative of the uplink TPC command being an FD type uplink TPC command. The communications manager 1020 is capable of, configured to, or operable to support a means for obtaining, from the UE, an uplink communication in a time resource of the set of FD time resources in accordance with the uplink TPC command.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for more efficient utilization of communication resources.

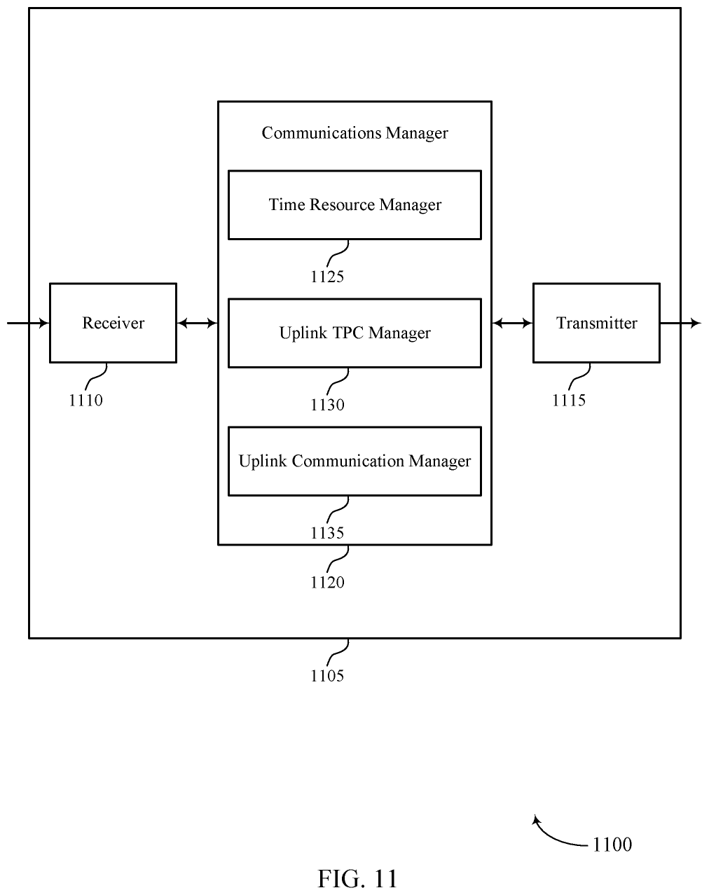

FIG. 11 shows a block diagram 1100 of a device 1105 that supports FD closed loop uplink power control commands in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of FD closed loop uplink power control commands as described herein. For example, the communications manager 1120 may include a time resource manager 1125, an uplink TPC manager 1130, an uplink communication manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The time resource manager 1125 is capable of, configured to, or operable to support a means for outputting, to a UE, control signaling that indicates a set of HD time resources and a set of FD time resources. The uplink TPC manager 1130 is capable of, configured to, or operable to support a means for outputting, to the UE, DCI that includes an uplink TPC command, where the DCI or transmission of the DCI is indicative of the uplink TPC command being an FD type uplink TPC command. The uplink communication manager 1135 is capable of, configured to, or operable to support a means for obtaining, from the UE, an uplink communication in a time resource of the set of FD time resources in accordance with the uplink TPC command.

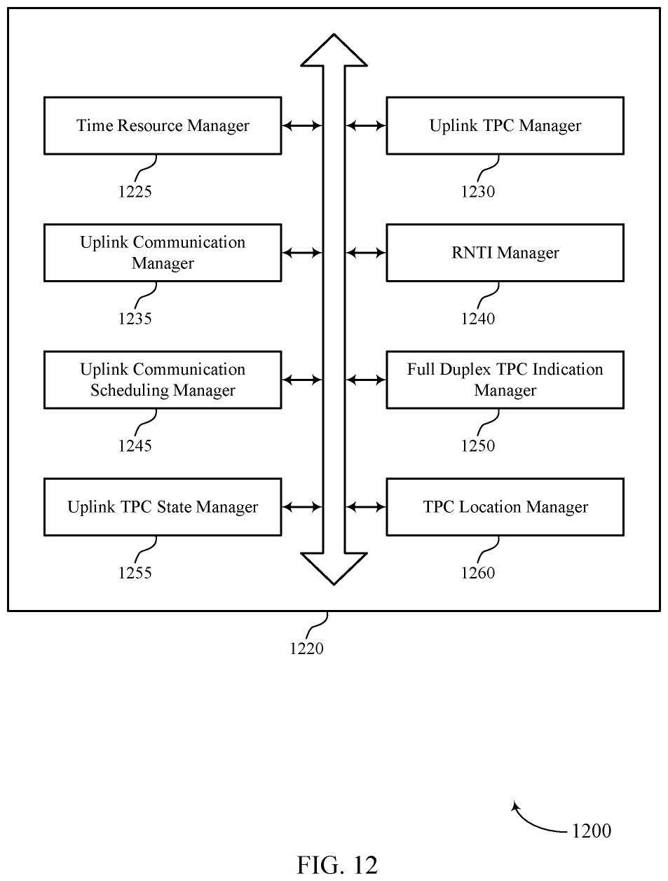

FIG. 12 shows a block diagram 1200 of a communications manager 1220 that supports FD closed loop uplink power control commands in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of FD closed loop uplink power control commands as described herein. For example, the communications manager 1220 may include a time resource manager 1225, an uplink TPC manager 1230, an uplink communication manager 1235, an RNTI manager 1240, an uplink communication scheduling manager 1245, an FD TPC indication manager 1250, an uplink TPC state manager 1255, a TPC location manager 1260, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The time resource manager 1225 is capable of, configured to, or operable to support a means for outputting, to a UE, control signaling that indicates a set of HD time resources and a set of FD time resources. The uplink TPC manager 1230 is capable of, configured to, or operable to support a means for outputting, to the UE, DCI that includes an uplink TPC command, where the DCI or transmission of the DCI is indicative of the uplink TPC command being an FD type uplink TPC command. The uplink communication manager 1235 is capable of, configured to, or operable to support a means for obtaining, from the UE, an uplink communication in a time resource of the set of FD time resources in accordance with the uplink TPC command.

In some examples, to support outputting the DCI, the RNTI manager 1240 is capable of, configured to, or operable to support a means for outputting the DCI scrambled by a RNTI for the UE associated with the set of FD time resources; where the DCI is indicative of the uplink TPC command being the FD type uplink TPC command based on the DCI being scrambled by the RNTI associated with the set of FD time resources.

In some examples, the RNTI manager 1240 is capable of, configured to, or operable to support a means for outputting, to the UE via the control signaling or via second control signaling, an indication of the RNTI for the UE.

In some examples, the RNTI manager 1240 is capable of, configured to, or operable to support a means for outputting, to the UE via the control signaling or via second control signaling, an indication of a second RNTI for the UE associated with the set of HD time resources, where the RNTI is derivative of the second RNTI.

In some examples, the DCI has a format associated with the set of FD time resources. In some examples, the DCI is indicative of the uplink TPC command being the FD type uplink TPC command based on the format.

In some examples, to support outputting the DCI, the uplink TPC manager 1230 is capable of, configured to, or operable to support a means for outputting the DCI that includes a second uplink TPC command of an HD type uplink TPC command, where the DCI is indicative of the uplink TPC command being the FD type uplink TPC command based on a location of the uplink TPC command within the DCI.

In some examples, the TPC location manager 1260 is capable of, configured to, or operable to support a means for outputting, to the UE via the control signaling or via second control signaling, an indication of a first location within a DCI format associated with FD type uplink TPC commands and a second location within the DCI format associated with HD type uplink TPC commands, where the DCI has the DCI format, where the location is the first location, and where the second uplink TPC command is within the second location.

In some examples, the location is adjacent to a second location of the second uplink TPC command.

In some examples, the location is a configured offset from a second location of the second uplink TPC command.

In some examples, to support outputting the DCI, the uplink communication scheduling manager 1245 is capable of, configured to, or operable to support a means for outputting the DCI scheduling the uplink communication in the time resource, where the transmission of the DCI is indicative of the uplink TPC command being the FD type uplink TPC command based on the time resource being an FD time resource.

In some examples, to support outputting the DCI, the FD TPC indication manager 1250 is capable of, configured to, or operable to support a means for outputting the DCI that includes a field indicating that the uplink TPC command is the FD type uplink TPC command.

In some examples, the uplink TPC state manager 1255 is capable of, configured to, or operable to support a means for outputting, to the UE via the control signaling or via second control signaling, an indication that a first uplink TPC command accumulator is associated with FD type uplink TPC commands and a second uplink TPC command accumulator is associated with HD type uplink TPC commands, where the uplink TPC command is applied to the first uplink TPC command accumulator based on the uplink TPC command being the FD type uplink TPC command, and where the uplink communication is obtained in accordance with the first uplink TPC command accumulator.

In some examples, the uplink TPC manager 1230 is capable of, configured to, or operable to support a means for outputting, to the UE, second DCI that includes a second uplink TPC command, where the second DCI or transmission of the second DCI is indicative of the second uplink TPC command being an HD type uplink TPC command, and where the second uplink TPC command is applied to the second uplink TPC command accumulator based on the second uplink TPC command being the HD type uplink TPC command. In some examples, the uplink communication manager 1235 is capable of, configured to, or operable to support a means for obtaining, from the UE, a second uplink communication in a second time resource of the set of HD time resources in accordance with the second uplink TPC command accumulator.

In some examples, the uplink TPC state manager 1255 is capable of, configured to, or operable to support a means for outputting, to the UE via the control signaling or via the second control signaling, an indication that a third uplink TPC command accumulator is associated with the FD type uplink TPC commands and that a fourth uplink TPC command accumulator is associated with the HD type uplink TPC commands.

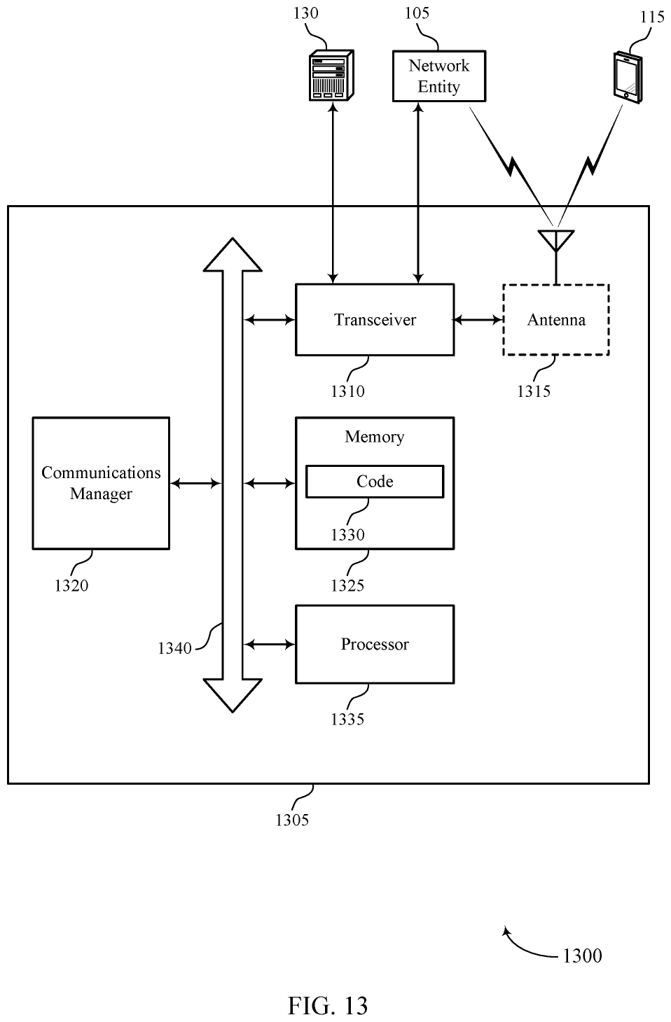

FIG. 13 shows a diagram of a system 1300 including a device 1305 that supports FD closed loop uplink power control commands in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting FD closed loop uplink power control commands). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting, to a UE, control signaling that indicates a set of HD time resources and a set of FD time resources. The communications manager 1320 is capable of, configured to, or operable to support a means for outputting, to the UE, DCI that includes an uplink TPC command, where the DCI or transmission of the DCI is indicative of the uplink TPC command being an FD type uplink TPC command. The communications manager 1320 is capable of, configured to, or operable to support a means for obtaining, from the UE, an uplink communication in a time resource of the set of FD time resources in accordance with the uplink TPC command.

By including or configuring the communications manager 1320 in accordance with examples as described herein, the device 1305 may support techniques for improved communication reliability, reduced latency, more efficient utilization of communication resources, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of FD closed loop uplink power control commands as described herein, or the at least one processor 1335 and the at least one memory 1325 may be otherwise configured to, individually or collectively, perform or support such operations.

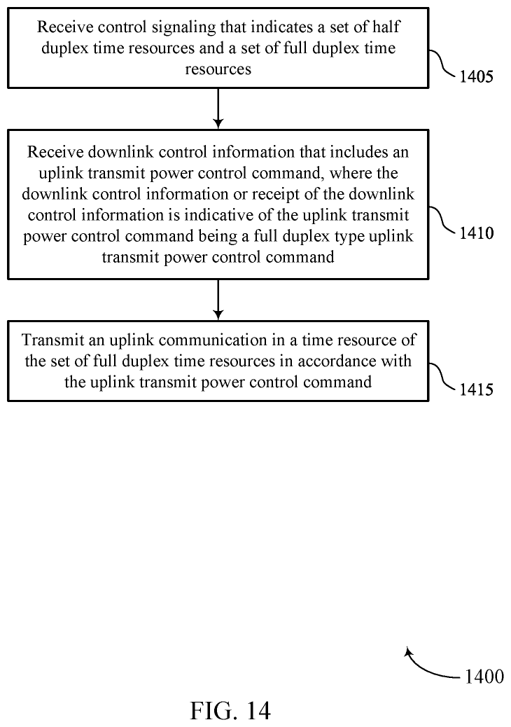

FIG. 14 shows a flowchart illustrating a method 1400 that supports FD closed loop uplink power control commands in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving control signaling that indicates a set of HD time resources and a set of FD time resources. The operations of block 1405 may be performed in accordance with examples as disclosed herein. In some examples, aspects of the operations of 1405 may be performed by a time resource manager 825 as described with reference to FIG. 8.

At 1410, the method may include receiving DCI that includes an uplink TPC command, where the DCI or receipt of the DCI is indicative of the uplink TPC command being an FD type uplink TPC command. The operations of block 1410 may be performed in accordance with examples as disclosed herein. In some examples, aspects of the operations of 1410 may be performed by an uplink TPC manager 830 as described with reference to FIG. 8.

At 1415, the method may include transmitting an uplink communication in a time resource of the set of FD time resources in accordance with the uplink TPC command. The operations of block 1415 may be performed in accordance with examples as disclosed herein. In some examples, aspects of the operations of 1415 may be performed by an uplink communication manager 835 as described with reference to FIG. 8.

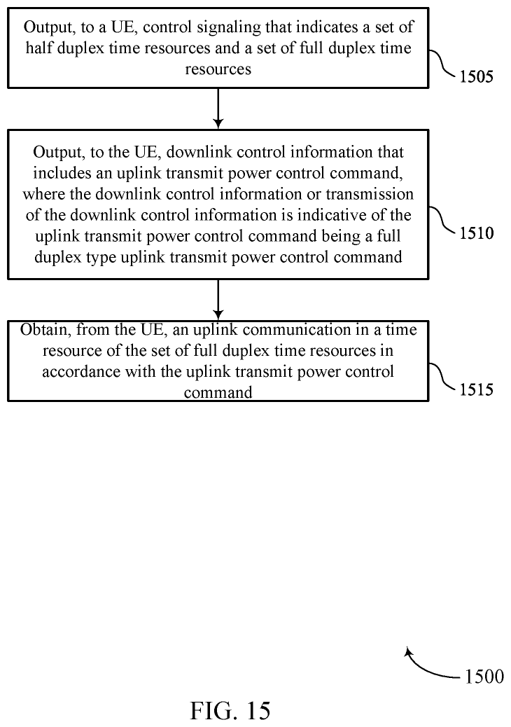

FIG. 15 shows a flowchart illustrating a method 1500 that supports FD closed loop uplink power control commands in accordance with aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include outputting, to a UE, control signaling that indicates a set of HD time resources and a set of FD time resources. The operations of block 1505 may be performed in accordance with examples as disclosed herein. In some examples, aspects of the operations of 1505 may be performed by a time resource manager 1225 as described with reference to FIG. 12.

At 1510, the method may include outputting, to the UE, DCI that includes an uplink TPC command, where the DCI or transmission of the DCI is indicative of the uplink TPC command being an FD type uplink TPC command. The operations of block 1510 may be performed in accordance with examples as disclosed herein. In some examples, aspects of the operations of 1510 may be performed by an uplink TPC manager 1230 as described with reference to FIG. 12.

At 1515, the method may include obtaining, from the UE, an uplink communication in a time resource of the set of FD time resources in accordance with the uplink TPC command. The operations of block 1515 may be performed in accordance with examples as disclosed herein. In some examples, aspects of the operations of 1515 may be performed by an uplink communication manager 1235 as described with reference to FIG. 12.

The following provides an overview of aspects of the present disclosure:

Aspect 1: A method for wireless communications at a UE, comprising: receiving control signaling that indicates a set of HD time resources and a set of FD time resources; receiving DCI that includes an uplink TPC command, wherein the DCI or receipt of the DCI is indicative of the uplink TPC command being a FD type uplink TPC command; and transmitting an uplink communication in a time resource of the set of FD time resources in accordance with the uplink TPC command.

Aspect 2: The method of aspect 1, wherein receiving the DCI comprises: receiving the DCI scrambled by a RNTI for the UE associated with the set of FD time resources; wherein the DCI is indicative of the uplink TPC command being the FD type uplink TPC command based at least in part on the DCI being scrambled by the RNTI associated with the set of FD time resources.

Aspect 3: The method of aspect 2, further comprising: receiving, via the control signaling or via second control signaling, an indication of the RNTI for the UE.

Aspect 4: The method of any of aspects 2 through 3, further comprising: receiving, via the control signaling or via second control signaling, an indication of a second RNTI for the UE associated with the set of HD time resources; and determining the RNTI for the UE based at least in part on the second RNTI.

Aspect 5: The method of any of aspects 1 through 4, wherein the DCI has a format associated with the set of FD time resources, and the DCI is indicative of the uplink TPC command being the FD type uplink TPC command based at least in part on the format.

Aspect 6: The method of any of aspects 1 through 5, wherein receiving the DCI comprises: receiving the DCI that comprises a second uplink TPC command of a HD type uplink TPC command, wherein the DCI is indicative of the uplink TPC command being the FD type uplink TPC command based at least in part on a location of the uplink TPC command within the DCI.

Aspect 7: The method of aspect 6, further comprising: receiving, via the control signaling or via second control signaling, an indication of a first location within a DCI format associated with FD type uplink TPC commands and a second location within the DCI format associated with HD type uplink TPC commands, wherein the DCI has the DCI format, wherein the location is the first location, and wherein the second uplink TPC command is within the second location.

Aspect 8: The method of any of aspects 6 through 7, wherein the location is adjacent to a second location of the second uplink TPC command.

Aspect 9: The method of any of aspects 6 through 7, wherein the location is a configured offset from a second location of the second uplink TPC command.

Aspect 10: The method of aspect 1, wherein receiving the DCI comprises: receiving the DCI scheduling the uplink communication in the time resource, wherein the receipt of the DCI is indicative of the uplink TPC command being the FD type uplink TPC command based at least in part on the time resource being a FD time resource.

Aspect 11: The method of any of aspects 1 through 10, wherein receiving the DCI comprises: receiving the DCI that comprises a field indicating that the uplink TPC command is the FD type uplink TPC command.

Aspect 12: The method of any of aspects 1 through 11, further comprising: receiving, via the control signaling or via second control signaling, an indication that a first uplink TPC command accumulator is associated with FD type uplink TPC commands and a second uplink TPC command accumulator is associated with HD type uplink TPC commands, wherein the uplink TPC command is applied to the first uplink TPC command accumulator based at least in part on the uplink TPC command being the FD type uplink TPC command, and wherein the uplink communication is transmitted in accordance with the first uplink TPC command accumulator.

Aspect 13: The method of aspect 12, further comprising: receiving second DCI that includes a second uplink TPC command, wherein the second DCI or receipt of the second DCI is indicative of the second uplink TPC command being a HD type uplink TPC command, and wherein the second uplink TPC command is applied to the second uplink TPC command accumulator based at least in part on the second uplink TPC command being the HD type uplink TPC command; and transmitting a second uplink communication in a second time resource of the set of HD time resources in accordance with the second uplink TPC command accumulator.

Aspect 14: The method of any of aspects 12 through 13, further comprising: receiving, via the control signaling or via the second control signaling, an indication that a third uplink TPC command accumulator is associated with the FD type uplink TPC commands and that a fourth uplink TPC command accumulator is associated with the HD type uplink TPC commands.

Aspect 15: A method for wireless communications at a network entity, comprising: outputting, to a UE, control signaling that indicates a set of HD time resources and a set of FD time resources; outputting, to the UE, DCI that includes an uplink TPC command, wherein the DCI or transmission of the DCI is indicative of the uplink TPC command being a FD type uplink TPC command; and obtaining, from the UE, an uplink communication in a time resource of the set of FD time resources in accordance with the uplink TPC command.

Aspect 16: The method of aspect 15, wherein outputting the DCI comprises: outputting the DCI scrambled by a RNTI for the UE associated with the set of FD time resources; wherein the DCI is indicative of the uplink TPC command being the FD type uplink TPC command based at least in part on the DCI being scrambled by the RNTI associated with the set of FD time resources.

Aspect 17: The method of aspect 16, further comprising: outputting, to the UE via the control signaling or via second control signaling, an indication of the RNTI for the UE.

Aspect 18: The method of any of aspects 16 through 17, further comprising: outputting, to the UE via the control signaling or via second control signaling, an indication of a second RNTI for the UE associated with the set of HD time resources, wherein the RNTI is derivative of the second RNTI.

Aspect 19: The method of any of aspects 15 through 18, wherein the DCI has a format associated with the set of FD time resources, and the DCI is indicative of the uplink TPC command being the FD type uplink TPC command based at least in part on the format.

Aspect 20: The method of any of aspects 15 through 19, wherein outputting the DCI comprises: outputting the DCI that comprises a second uplink TPC command of a HD type uplink TPC command, wherein the DCI is indicative of the uplink TPC command being the FD type uplink TPC command based at least in part on a location of the uplink TPC command within the DCI.

Aspect 21: The method of aspect 20, further comprising: outputting, to the UE via the control signaling or via second control signaling, an indication of a first location within a DCI format associated with FD type uplink TPC commands and a second location within the DCI format associated with HD type uplink TPC commands, wherein the DCI has the DCI format, wherein the location is the first location, and wherein the second uplink TPC command is within the second location.

Aspect 22: The method of any of aspects 20 through 21, wherein the location is adjacent to a second location of the second uplink TPC command.

Aspect 23: The method of any of aspects 20 through 21, wherein the location is a configured offset from a second location of the second uplink TPC command.

Aspect 24: The method of any aspect 15, wherein outputting the DCI comprises: outputting the DCI scheduling the uplink communication in the time resource, wherein the transmission of the DCI is indicative of the uplink TPC command being the FD type uplink TPC command based at least in part on the time resource being a FD time resource.

Aspect 25: The method of any of aspects 15 through 24, wherein outputting the DCI comprises: outputting the DCI that comprises a field indicating that the uplink TPC command is the FD type uplink TPC command.

Aspect 26: The method of any of aspects 15 through 25, further comprising: outputting, to the UE via the control signaling or via second control signaling, an indication that a first uplink TPC command accumulator is associated with FD type uplink TPC commands and a second uplink TPC command accumulator is associated with HD type uplink TPC commands, wherein the uplink TPC command is applied to the first uplink TPC command accumulator based at least in part on the uplink TPC command being the FD type uplink TPC command, and wherein the uplink communication is obtained in accordance with the first uplink TPC command accumulator.

Aspect 27: The method of aspect 26, further comprising: outputting, to the UE, second DCI that includes a second uplink TPC command, wherein the second DCI or transmission of the second DCI is indicative of the second uplink TPC command being a HD type uplink TPC command, and wherein the second uplink TPC command is applied to the second uplink TPC command accumulator based at least in part on the second uplink TPC command being the HD type uplink TPC command; and obtaining, from the UE, a second uplink communication in a second time resource of the set of HD time resources in accordance with the second uplink TPC command accumulator.

Aspect 28: The method of any of aspects 26 through 27, further comprising: outputting, to the UE via the control signaling or via the second control signaling, an indication that a third uplink TPC command accumulator is associated with the FD type uplink TPC commands and that a fourth uplink TPC command accumulator is associated with the HD type uplink TPC commands.

Aspect 29: A UE for wireless communications, comprising one or more memories storing processor-executable code, and one or more processors coupled with the one or more memories and individually or collectively operable to execute the code to cause the UE to perform a method of any of aspects 1 through 14.

Aspect 30: A UE for wireless communications, comprising at least one means for performing a method of any of aspects 1 through 14.

Aspect 31: A non-transitory computer-readable medium storing code for wireless communications, the code comprising instructions executable by one or more processors to perform a method of any of aspects 1 through 14.

Aspect 32: A network entity for wireless communications, comprising one or more memories storing processor-executable code, and one or more processors coupled with the one or more memories and individually or collectively operable to execute the code to cause the network entity to perform a method of any of aspects 15 through 28.

Aspect 33: A network entity for wireless communications, comprising at least one means for performing a method of any of aspects 15 through 28.

Aspect 34: A non-transitory computer-readable medium storing code for wireless communications, the code comprising instructions executable by one or more processors to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling that indicates a set of half duplex time resources and a set of full duplex time resources;
receive downlink control information that includes an uplink transmit power control command, wherein the downlink control information or receipt of the downlink control information is indicative of the uplink transmit power control command being a full duplex type uplink transmit power control command; and
transmit an uplink communication in a time resource of the set of full duplex time resources in accordance with the uplink transmit power control command.

2. The UE of claim 1, wherein, to receive the downlink control information, the one or more processors are individually or collectively operable to execute the code to cause the UE to:
receive the downlink control information scrambled by a radio network temporary identifier for the UE associated with the set of full duplex time resources; wherein the downlink control information is indicative of the uplink transmit power control command being the full duplex type uplink transmit power control command based at least in part on the downlink control information being scrambled by the radio network temporary identifier associated with the set of full duplex time resources.

3. The UE of claim 2, wherein the one or more processors are individually or collectively further operable to execute the code to cause the UE to:
receive, via the control signaling or via second control signaling, an indication of the radio network temporary identifier for the UE.

4. The UE of claim 2, wherein the one or more processors are individually or collectively further operable to execute the code to cause the UE to:
receive, via the control signaling or via second control signaling, an indication of a second radio network temporary identifier for the UE associated with the set of half duplex time resources; and
determine the radio network temporary identifier for the UE based at least in part on the second radio network temporary identifier.

5. The UE of claim 1, wherein:
the downlink control information has a format associated with the set of full duplex time resources, and
the downlink control information is indicative of the uplink transmit power control command being the full duplex type uplink transmit power control command based at least in part on the format.

6. The UE of claim 1, wherein, to receive the downlink control information, the one or more processors are individually or collectively operable to execute the code to cause the UE to:
receive the downlink control information that comprises a second uplink transmit power control command of a half duplex type uplink transmit power control command, wherein the downlink control information is indicative of the uplink transmit power control command being the full duplex type uplink transmit power control command based at least in part on a location of the uplink transmit power control command within the downlink control information.

7. The UE of claim 6, wherein the one or more processors are individually or collectively further operable to execute the code to cause the UE to:
receive, via the control signaling or via second control signaling, an indication of a first location within a downlink control information format associated with full duplex type uplink transmit power control commands and a second location within the downlink control information format associated with half duplex type uplink transmit power control commands, wherein the downlink control information has the downlink control information format, wherein the location is the first location, and wherein the second uplink transmit power control command is within the second location.

8. The UE of claim 6, wherein the location is adjacent to a second location of the second uplink transmit power control command.

9. The UE of claim 6, wherein the location is a configured offset from a second location of the second uplink transmit power control command.

10. The UE of claim 1, wherein, to receive the downlink control information, the one or more processors are individually or collectively operable to execute the code to cause the UE to:
receive the downlink control information scheduling the uplink communication in the time resource, wherein the receipt of the downlink control information is indicative of the uplink transmit power control command being the full duplex type uplink transmit power control command based at least in part on the time resource being a full duplex time resource.

11. The UE of claim 1, wherein, to receive the downlink control information, the one or more processors are individually or collectively operable to execute the code to cause the UE to:
receive the downlink control information that comprises a field indicating that the uplink transmit power control command is the full duplex type uplink transmit power control command.

12. The UE of claim 1, wherein the one or more processors are individually or collectively further operable to execute the code to cause the UE to:
receive, via the control signaling or via second control signaling, an indication that a first uplink transmit power control command accumulator is associated with full duplex type uplink transmit power control commands and a second uplink transmit power control command accumulator is associated with half duplex type uplink transmit power control commands, wherein the uplink transmit power control command is applied to the first uplink transmit power control command accumulator based at least in part on the uplink transmit power control command being the full duplex type uplink transmit power control command, and wherein the uplink communication is transmitted in accordance with the first uplink transmit power control command accumulator.

13. The UE of claim 12, wherein the one or more processors are individually or collectively further operable to execute the code to cause the UE to:
receive second downlink control information that includes a second uplink transmit power control command, wherein the second downlink control information or receipt of the second downlink control information is indicative of the second uplink transmit power control command being a half duplex type uplink transmit power control command, and wherein the second uplink transmit power control command is applied to the second uplink transmit power control command accumulator based at least in part on the second uplink transmit power control command being the half duplex type uplink transmit power control command; and
transmit a second uplink communication in a second time resource of the set of half duplex time resources in accordance with the second uplink transmit power control command accumulator.

14. The UE of claim 12, wherein the one or more processors are individually or collectively further operable to execute the code to cause the UE to:
receive, via the control signaling or via the second control signaling, an indication that a third uplink transmit power control command accumulator is associated with the full duplex type uplink transmit power control commands and that a fourth uplink transmit power control command accumulator is associated with the half duplex type uplink transmit power control commands.

15. A network entity, comprising:
one or more memories storing processor-executable code; and
one or more processors coupled with the one or more memories and individually or collectively operable to execute the code to cause the network entity to:
output, to a user equipment (UE), control signaling that indicates a set of half duplex time resources and a set of full duplex time resources;
output, to the UE, downlink control information that includes an uplink transmit power control command, wherein the downlink control information or transmission of the downlink control information is indicative of the uplink transmit power control command being a full duplex type uplink transmit power control command; and
obtain, from the UE, an uplink communication in a time resource of the set of full duplex time resources in accordance with the uplink transmit power control command.

16. The network entity of claim 15, wherein, to output the downlink control information, the one or more processors are individually or collectively operable to execute the code to cause the network entity to:
output the downlink control information scrambled by a radio network temporary identifier for the UE associated with the set of full duplex time resources;
wherein the downlink control information is indicative of the uplink transmit power control command being the full duplex type uplink transmit power control command based at least in part on the downlink control information being scrambled by the radio network temporary identifier associated with the set of full duplex time resources.

17. The network entity of claim 16, wherein the one or more processors are individually or collectively further operable to execute the code to cause the network entity to:
output, to the UE via the control signaling or via second control signaling, an indication of the radio network temporary identifier for the UE.

18. The network entity of claim 16, wherein the one or more processors are individually or collectively further operable to execute the code to cause the network entity to:
output, to the UE via the control signaling or via second control signaling, an indication of a second radio network temporary identifier for the UE associated with the set of half duplex time resources, wherein the radio network temporary identifier is derivative of the second radio network temporary identifier.

19. The network entity of claim 15, wherein:
the downlink control information has a format associated with the set of full duplex time resources, and
the downlink control information is indicative of the uplink transmit power control command being the full duplex type uplink transmit power control command based at least in part on the format.

20. The network entity of claim 15, wherein, to output the downlink control information, the one or more processors are individually or collectively operable to execute the code to cause the network entity to:
output the downlink control information that comprises a second uplink transmit power control command of a half duplex type uplink transmit power control command, wherein the downlink control information is indicative of the uplink transmit power control command being the full duplex type uplink transmit power control command based at least in part on a location of the uplink transmit power control command within the downlink control information.

21. The network entity of claim 20, wherein the one or more processors are individually or collectively further operable to execute the code to cause the network entity to:
output, to the UE via the control signaling or via second control signaling, an indication of a first location within a downlink control information format associated with full duplex type uplink transmit power control commands and a second location within the downlink control information format associated with half duplex type uplink transmit power control commands, wherein the downlink control information has the downlink control information format, wherein the location is the first location, and wherein the second uplink transmit power control command is within the second location.

22. The network entity of claim 20, wherein the location is adjacent to a second location of the second uplink transmit power control command.

23. The network entity of claim 20, wherein the location is a configured offset from a second location of the second uplink transmit power control command.

24. The network entity of claim 15, wherein, to output the downlink control information, the one or more processors are individually or collectively operable to execute the code to cause the network entity to:
output the downlink control information scheduling the uplink communication in the time resource, wherein the transmission of the downlink control information is indicative of the uplink transmit power control command being the full duplex type uplink transmit power control command based at least in part on the time resource being a full duplex time resource.

25. The network entity of claim 15, wherein, to output the downlink control information, the one or more processors are individually or collectively operable to execute the code to cause the network entity to:
output the downlink control information that comprises a field indicating that the uplink transmit power control command is the full duplex type uplink transmit power control command.

26. The network entity of claim 15, wherein the one or more processors are individually or collectively further operable to execute the code to cause the network entity to:
output, to the UE via the control signaling or via second control signaling, an indication that a first uplink transmit power control command accumulator is associated with full duplex type uplink transmit power control commands and a second uplink transmit power control command accumulator is associated with half duplex type uplink transmit power control commands, wherein the uplink transmit power control command is applied to the first uplink transmit power control command accumulator based at least in part on the uplink transmit power control command being the full duplex type uplink transmit power control command, and wherein the uplink communication is obtained in accordance with the first uplink transmit power control command accumulator.

27. The network entity of claim 26, wherein the one or more processors are individually or collectively further operable to execute the code to cause the network entity to:
output, to the UE, second downlink control information that includes a second uplink transmit power control command, wherein the second downlink control information or transmission of the second downlink control information is indicative of the second uplink transmit power control command being a half duplex type uplink transmit power control command, and wherein the second uplink transmit power control command is applied to the second uplink transmit power control command accumulator based at least in part on the second uplink transmit power control command being the half duplex type uplink transmit power control command; and
obtain, from the UE, a second uplink communication in a second time resource of the set of half duplex time resources in accordance with the second uplink transmit power control command accumulator.

28. The network entity of claim 26, wherein the one or more processors are individually or collectively further operable to execute the code to cause the network entity to:
output, to the UE via the control signaling or via the second control signaling, an indication that a third uplink transmit power control command accumulator is associated with the full duplex type uplink transmit power control commands and that a fourth uplink transmit power control command accumulator is associated with the half duplex type uplink transmit power control commands.

29. A method for wireless communications at a user equipment (UE), comprising:
receiving control signaling that indicates a set of half duplex time resources and a set of full duplex time resources;
receiving downlink control information that includes an uplink transmit power control command, wherein the downlink control information or receipt of the downlink control information is indicative of the uplink transmit power control command being a full duplex type uplink transmit power control command; and
transmitting an uplink communication in a time resource of the set of full duplex time resources in accordance with the uplink transmit power control command.

30. A method for wireless communications at a network entity, comprising:
outputting, to a user equipment (UE), control signaling that indicates a set of half duplex time resources and a set of full duplex time resources;
outputting, to the UE, downlink control information that includes an uplink transmit power control command, wherein the downlink control information or transmission of the downlink control information is indicative of the uplink transmit power control command being a full duplex type uplink transmit power control command; and
obtaining, from the UE, an uplink communication in a time resource of the set of full duplex time resources in accordance with the uplink transmit power control command.
